(19) United States
(12) Patent Application Publication
(10) Pub. No.: US 2017/0157986 A1
(43) Pub. Date: Jun. 8, 2017

(54) TIRE AND MANUFACTURING METHOD OF TIRE

(71) Applicant: TOYO TIRE & RUBBER CO., LTD., Osaka (JP)

(72) Inventor: Shuichi Nishikawa, Osaka-shi (JP)

(73) Assignee: TOYO TIRE & RUBBER CO., LTD., Osaka (JP)

(21) Appl. No.: 15/351,704

(22) Filed: Nov. 15, 2016

(30) Foreign Application Priority Data
Dec. 3, 2015 (JP) 2015-236573
Dec. 3, 2015 (JP) 2015-236578
Dec. 3, 2015 (JP) 2015-236582

(51) Int. Cl. B60C 11/00; B29D 30/30

(52) U.S. Cl. CPC B60C 11/00; B29D 30/3028; B60C 2011/0091; B29D 2030/3092

(57) ABSTRACT

In a tire, a ribbon rubber includes a first inclined portion which is placed at a slant with respect to a tire-circumferential direction from an outer second row of a tire-width direction to an outer first row, a first parallel portion having an end connected to an end of the first inclined portion, the first parallel portion being placed parallel to the tire-circumferential direction to configure the outer first row of the tire-width direction, and an outermost inclined portion having an end connected to an end of the first parallel portion, the outermost inclined portion being placed at a slant with respect to the tire-circumferential direction. The outermost inclined portion is placed along the first inclined portion, and is placed outside of the outer first row from the outer first row of the tire-width direction.

### CROSS REFERENCE TO RELATED APPLICATIONS

This application claims the benefit of priority of Japanese application no. 2015-236573, filed on Dec. 3, 2015, Japanese application no. 2015-236578, filed on Dec. 3, 2015, and Japanese application no. 2015-236582, filed on Dec. 3, 2015, which are incorporated herein by reference.

### BACKGROUND OF THE INVENTION

Field of the Invention

The present invention relates to a tire including a rubber portion formed from a ribbon rubber which is spirally wound along a tire-circumferential direction, and also relates to a manufacturing method of the tire.

Description of the Related Art

Conventionally, as a tire, there has been known a tire including a rubber portion formed from a ribbon rubber which is spirally wound around a tire-circumferential direction (e.g., JP-A-2006-69130, JP-A-2009-119824, and JP-A-2009-73177). More specifically, by vulcanizing an unvulcanized tire including a rubber portion around which an unvulcanized ribbon rubber is spirally wound.

### SUMMARY OF THE INVENTION

Hence, it is an object of the present invention to provide a tire capable of restraining a rubber weight from becoming non-uniform, and to provide a manufacturing method of the tire.

There is provided a tire, which includes:

a rubber portion formed from ribbon rubber which is spirally wound along a tire-circumferential direction, wherein

the ribbon rubber includes:

a first inclined portion which is placed at a slant with respect to the tire-circumferential direction from an outer second row of a tire-width direction to an outer first row;

a first parallel portion having an end connected to an end of the first inclined portion, the first parallel portion being placed parallel to the tire-circumferential direction to configure the outer first row of the tire-width direction; and

an outermost inclined portion having an end connected to an end of the first parallel portion, the outermost inclined portion being placed at a slant with respect to the tire-circumferential direction, and

wherein the outermost inclined portion is placed along the first inclined portion, and is placed outside of the outer first row from the outer first row of the tire-width direction.

Also, the tire may have a configuration in which:

a cross-sectional area of the outermost inclined portion is smaller than a cross-sectional area of the first parallel portion.

Also, the tire may have a configuration in which:

the outermost inclined portion is placed at a slant with respect to the tire-circumferential direction from outside of the outer first row of the tire-width direction toward the outer first row in a winding direction,

a winding-starting end of the first parallel portion is connected to a winding-finishing end of the outermost inclined portion, the first parallel portion is placed parallel to the tire-circumferential direction to configure the outer first row of the tire-width direction, and

a winding-starting end of the first inclined portion is connected to a winding-finishing end of the first parallel portion, and the first inclined portion is placed at a slant with respect to the tire-circumferential direction from the outer first row of the tire-width direction toward an outer second row in the winding direction.

Also, the tire may have a configuration in which:

the first inclined portion is placed at a slant with respect to the tire-circumferential direction from the outer second row of the tire-width direction toward the outer first row in the winding direction,

a winding-starting end of the first parallel portion is connected to a winding-finishing end of the first inclined portion, the first parallel portion is placed parallel to the tire-circumferential direction to configure the outer first row of the tire-width direction, and

a winding-starting end of the outermost inclined portion is connected to a winding-finishing end of the first parallel portion, and the outermost inclined portion is placed at a slant with respect to the tire-circumferential direction from the outer first row of the tire-width direction toward outside of the cuter first row in the winding direction.

There is provided a tire, which includes:

a rubber portion formed from ribbon rubber which is spirally wound along a tire-circumferential direction, wherein

the ribbon rubber includes:

a parallel portion having a first end which is an end of the ribbon rubber and placed parallel to the tire-circumferential direction to configure a predetermined row of a tire-width direction, and

an inclined portion having a first end connected to a second end of the parallel portion, the inclined portion being placed at a slant with respect to the tire-circumferential direction from the predetermined row of the tire-width direction to a row which is adjacent to the predetermined row, and

the parallel portion includes a standard portion having the same cross-sectional area as a cross-sectional area of the second end, and a small portion placed close to the first end and having a cross-sectional area smaller than the cross-sectional area of the standard portion,

wherein positions of the first end and the second end of the parallel portion are the same in the tire-circumferential direction, and

a portion of the inclined portion is superposed on a portion of the small portion, and

a rubber volume at a location where the inclined portion is located in the predetermined row of the tire-width direction is equal to an insufficient rubber volume of the small portion with respect to the standard portion having the same length.

Also, the tire may have a configuration in which:

a cross-sectional shape of the small portion is similar to a cross-sectional shape of the standard portion such that the cross-sectional area of the small portion gradually becomes larger from the first end of the parallel portion toward the standard portion.

Also, the tire may have a configuration in which:

a winding-starting end of the parallel portion is a winding-starting end of the ribbon rubber, the parallel portion is placed parallel to the tire-circumferential direction to configure the predetermined row of the tire-width direction,

a winding-starting end of the inclined portion is connected to a winding-finishing end of the parallel portion, the inclined portion is placed at a slant with respect to the tire-circumferential direction from the predetermined row of the tire-width direction toward a row which is adjacent to the predetermined row in the winding direction, and

a portion of the inclined portion is superposed on a portion of the small portion such that the portion of the inclined portion covers the portion of the small portion from outside in a tire-radial direction.

Also, the tire may have a configuration in which:

the inclined portion is placed at a slant with respect to the tire-circumferential direction from the adjacent row of the tire-width direction toward the predetermined row in the winding direction,

the winding-starting end of the parallel portion is connected to a winding-finishing end of the inclined portion, the parallel portion is placed parallel to the tire-circumferential direction to configure the predetermined row of the tire-width direction, the winding-finishing end of the parallel portion is a winding-finishing end of the ribbon rubber, and

a portion of the inclined portion is superposed on a portion of the small portion such that the portion of the inclined portion covers the portion of the small portion from outside in a tire-radial direction.

There is provided a tire, which includes:

a rubber portion formed from ribbon rubber which is spirally wound along a tire-circumferential direction, wherein

the ribbon rubber is alternately provided with parallel portions placed parallel to the tire-circumferential direction, and inclined portions which are inclined with respect to the tire-circumferential direction and placed between adjacent two rows of a tire-width direction, such that the ribbon rubber is spirally wound along the tire-circumferential direction,

an end of the ribbon rubber in a length direction is an end of the parallel portion which configures a predetermined row of the tire-width direction,

the ribbon rubber includes a standard portion placed at an intermediate portion in the length direction and having a uniform cross-sectional area, and a small portion placed on an end in the length direction and having a cross-sectional area smaller than a cross-sectional area of the standard portion, and

at least the predetermined row of the tire-width direction and the row which is adjacent to the predetermined row are configured by the small portion.

Also, the tire may have a configuration in which:

a cross-sectional area of the parallel portion configured by the small portion is uniform, and

a cross-sectional area of the inclined portion configured by the small portion becomes larger from an end of the ribbon rubber in the length direction toward the standard portion.

Also, the tire may have a configuration in which: a cross-sectional area of the small portion gradually becomes larger from the end of the ribbon rubber in the length direction toward the standard portion.

Also, the tire may have a configuration in which:

the rubber portion is a tread rubber,

the tread rubber includes a plurality of peripheral grooves extending along the tire-circumferential direction,

a shoulder region in the tire-width direction of the tread rubber located outside of the peripheral grooves which is placed on outermost side in the tire-width direction has a thickness in a tire-radial direction which is smaller than an inner center region,

an end of the ribbon rubber in the length direction is placed in the shoulder region, and

the shoulder region is configured by the small portion.

There is provided a manufacturing method of a tire including a rubber portion formed from ribbon rubber which is spirally wound along a tire-circumferential direction,

the method includes:

pushing out rubber to form the ribbon rubber having a uniform cross-sectional shape,

winding the ribbon rubber around a rotating winding portion, and

changing a cross-sectional area of the wound ribbon rubber by changing a tensile force to be applied to the ribbon rubber for expanding the ribbon rubber.

Also, the manufacturing method of a tire may have a method in which:

rotation speed of the winding portion is changed in order to change the tensile force to be applied to the ribbon rubber.

As described above, the tire and the manufacturing method of the tire have excellent effects to make it possible to restrain a rubber weight from becoming non-uniform.

### BRIEF DESCRIPTION OF THE DRAWINGS

FIG. 1 is a sectional view of an essential part of a tire meridian plane of a tire according to an embodiment;

FIG. 2 is a schematic diagram of manufacturing equipment for forming the tire of the embodiment;

FIG. 3 is a perspective view of a ribbon rubber of the embodiment;

FIGS. 4 and 5 are perspective views for describing a wound state of a ribbon rubber of a tire according to a first embodiment;

FIGS. 6 and 7 are front views of an essential part for describing a wound state of a ribbon rubber of a comparative example;

FIGS. 8 to 11 are front views of an essential part for describing the wound state of the of the ribbon rubber of the first embodiment;

FIG. 12 is a front view of an essential part for describing a wound state of a ribbon rubber of a modification of the first embodiment;

FIGS. 13 to 20 are front views of an essential part for describing the wound state of the of the ribbon rubber of the second embodiment;

FIGS. 21 to 29 are front views of an essential part for describing the wound state of the of the ribbon rubber of the third embodiment;

FIG. 30 is a schematic diagram of manufacturing equipment for forming a tire of another embodiment; and

FIG. 31 is a schematic diagram of manufacturing equipment for forming a tire of another embodiment.

### DETAILED DESCRIPTION OF PREFERRED EMBODIMENTS

### First Embodiment

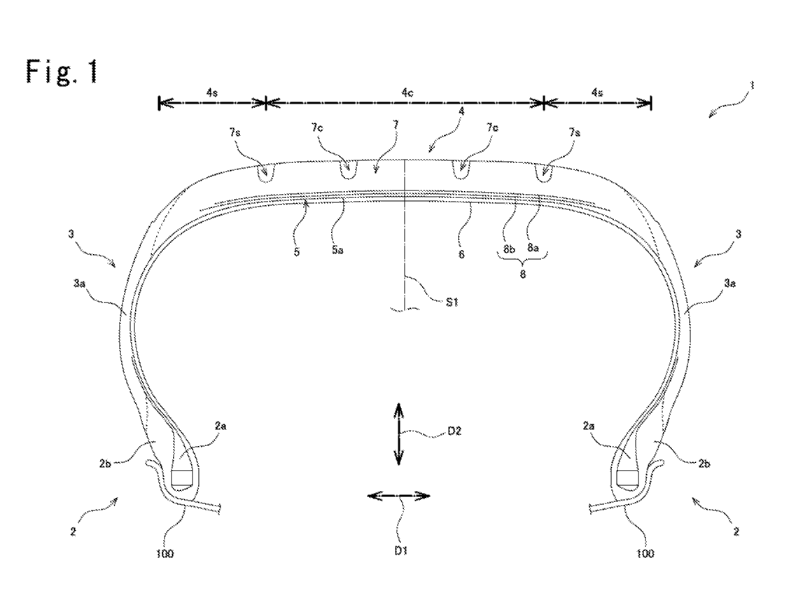

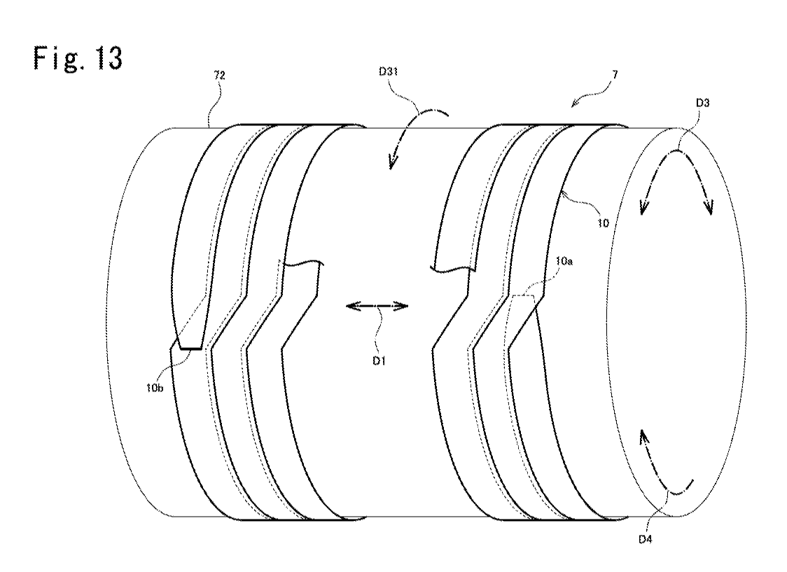

A tire of a first embodiment will be described below with reference to FIGS. 1 to 12. In the drawings (FIGS. 13 to 31 are also the same), sizes of the drawings do not absolutely match with actual sizes, and size ratios between the drawings do not absolutely match with each other.

As shown in FIG. 1, the tire 1 according to one of embodiments includes a pair of bead portions 2 each having a bead 2a, sidewall portions 3 extending from the respective bead portions 2 outward in a tire-radial direction D2, and a tread portion 4 which is connected to outer ends of the pair of sidewall portions 3 in the tire-radial direction D2 to configure a tread surface. In this embodiment, the tire 1 is a pneumatic tire into which air is charged. The tire 1 is mounted around a rim 100.

In FIG. 1, a tire-width direction D1 is a lateral direction. The tire-radial direction D2 is a radial direction of the tire 1, and a tire-circumferential direction D3 (not shown in FIG. 1) is a direction around a rotation axis of the tire. In FIG. 1, the tire-radial direction D2 which is parallel to a paper sheet is a vertical direction. A tire equatorial plane S1 is a plane which intersects with the tire rotation axis at right angles and which is located at a center of the tire-width direction D1. The tire meridian surface includes the tire rotation axis, and intersects with the tire equatorial plane S1 at right angles.

The tire 1 also includes a carcass layer 5 extending between the pair of beads 2a and 2a, and an inner liner 6 placed on an inner side of the carcass layer 5. The inner liner 6 has an excellent function to prevent gas from passing through the inner liner 6 for maintaining air pressure. The carcass layer 5 and the inner liner 6 are placed along an inner periphery of the tire across the bead portions 2, the sidewall portions 3 and the tread portion 4.

In this embodiment, the carcass layer 5 is composed of one carcass ply 5a. The carcass ply 5a is folded back around the beads 2a and 2a such that the carcass ply 5a surrounds the beads 2a and 2a. To configure an outer surface, the bead portions 2 respectively include rim strip rubbers 2b placed on an outer side of the carcass ply 5a in the tire-width direction D1. To configure the outer surface, the sidewall portions 3 respectively include sidewall rubbers 3a placed on an outer side of the carcass layer 5 in the tire-width direction D1.

The tread portion 4 includes a tread rubber 7 placed on an outer peripheral side of the carcass layer 5 to configure a tread surface (ground-contact surface) which comes into contact with the ground. The tread portion 4 also includes a belt layer 8 placed on an outer peripheral side of the carcass layer 5 and on an inner periphery side of the tread rubber 7. In this embodiment, the belt layer 3 includes two layers, i.e., two belt plies 8a and 8b. In this embodiment, ends of the tread rubber 7 in the tire-width direction D1 are laminated on ends of the sidewall rubbers 3a. That is, the tire 1 of the embodiment is of a side-on tread structure.

The tread rubber 7 includes a plurality of peripheral grooves 7c, 7s extending along the tire-circumferential direction D3. In this embodiment, four peripheral grooves 7c, 7s are provided. The peripheral grooves 7a of the plurality of peripheral grooves 7c, 7s which are placed on the outermost sides in the tire-width direction D1 are called shoulder peripheral grooves 7s, and the peripheral grooves 7c placed between the pair of shoulder peripheral grooves 7s, 7s are called center peripheral grooves 7c.

The tread portion 4 is divided into a plurality of regions by the plurality of peripheral grooves 7c, 7s. Regions of the tread portion 4 which are located outside of the shoulder peripheral grooves 7s in the tire-width direction D1 are called shoulder regions 4s, and a region of the tread portion 4 placed between the pair of shoulder peripheral grooves 7s, 7s is called a center region 4c.

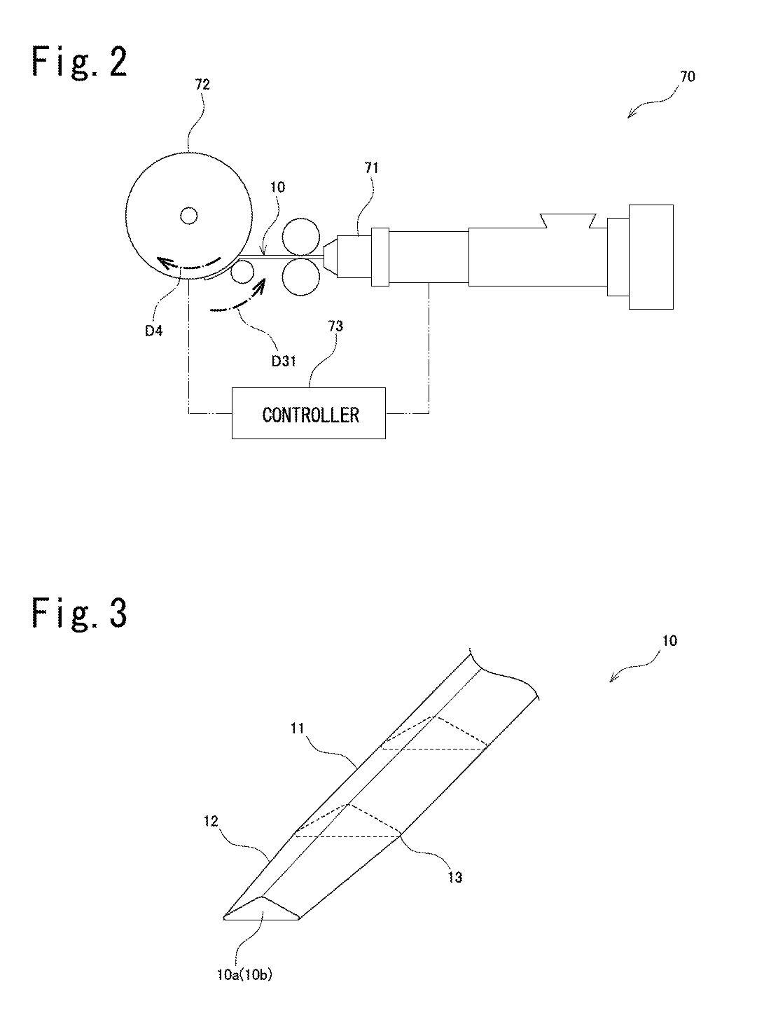

The tire 1 includes a rubber portion formed from a ribbon rubber which is spirally wound along the tire-circumferential direction D3 around the tire rotation axis. In this embodiment, this rubber portion is the tread rubber 7. Here, a forming device 70 which forms the rubber portion will be described with reference to FIG. 2.

As shown in FIG. 2, the forming device 70 includes a push-out portion 71 which pushes out rubber, and a winding portion 72 around which a cord-shaped ribbon rubber 10 is wound. The cord-shaped ribbon rubber 10 is pushed out from the push-out portion 71 to be formed. The forming device 70 also includes a controller 73 which controls the push-out portion 71 and the winding portion 72.

The push-out portion 71 pushes out the rubber such that a cross-sectional shape of the ribbon rubber 10 becomes uniform. Further, the push-out portion 71 pushes out the rubber such that a rubber-push out amount per unit time becomes uniform.

The winding portion 72 is formed into a columnar shape, and the winding portion 72 can rotate around the axis (rotation direction D4). According to this, if the winding portion 72 rotates, the pushed-out and formed ribbon rubber 10 is wound around an outer periphery of the winding portion 72. The winding portion 72 can be relatively displaced in the axial direction with respect to the push-out portion 71. in this embodiment, the winding portion 72 can move in the axial direction.

Of the tire-circumferential direction D3, a direction in which the ribbon rubber 10 is wound and moved is called a winding direction D31. In this embodiment, of the tire-circumferential direction D3, the winding direction D31 is opposite from a rotating direction D4 of the winding portion 72.

The controller 73 controls a push-out amount of the ribbon rubber 10 and a state of the ribbon rubber 10 (e.g., temperature thereof) by controlling the push-out portion 71. The controller 73 controls rotation speed of the winding portion 72 and a position of the winding portion 72 with respect to the push-out portion 71 by controlling the winding portion 72.

As shown in FIG. 3, the ribbon rubber 10 includes a standard portion 11 having a uniform cross sectional area, and a pair of small portions 12 each having a cross-sectional area smaller than that of the standard portion 11. The expression that the cross-sectional area of the standard portion 11 is uniform not only includes a case where the cross-sectional area is completely equal, but also includes a case where the cross-sectional area is substantially equal, e.g., includes unintended manufacturing tolerances which are generated for not changing the cross-sectional area. In this embodiment, the expression that the cross-sectional area of the standard portion 11 is uniform includes a scope of about ±10% of the standard design cross-sectional area for example.

The standard portion 11 is located at an intermediate portion of the ribbon rubber 10 in its length direction, and the small portions 12 are placed close to ends 10a, 10b of the ribbon rubber 10 in the length direction. That is, the standard portion 11 is placed between a pair of the small portions 12 in the length direction of the ribbon rubber 10. A shape of a cross-sectional area of each of the small portions 12 is similar to that of the standard portion 11. Here, the expression “shapes which are similar to each other” not only includes a case where the shapes are completely similar to each other, but also includes a case where the shapes are substantially similar to each other, e.g., also includes a shape giving an impression that the shapes are similar to each other at first glance when the shapes are observed with the naked eye.

A cross-sectional area of the ribbon rubber 10 gradually increases from the ends 10a, 10b, and becomes the standard portion 11 at a predetermined boundary position 13. For example, the cross-sectional areas of the ends 10a, 10b (tip ends of small portions 12) of the ribbon rubber 10 are in a range of 10% to 60% of the cross-sectional area of the standard portion 11 of the ribbon rubber 10 (base ends of small portions 12), preferably in a range of 20% to 50%, and 50% in this embodiment.

In this embodiment, the cross-sectional shape of the ribbon rubber 10 is a substantially triangular shape having the maximum thickness at its central portion in its width direction. and the thickness gradually reduces from the central portion toward both side ends. In the cross-sectional shape (cross-sectional shape of standard portion 11), it is preferable that a width size is in a range of 5 mm to 50 mm, a thickness size of the central portion in the width direction is in a range of 0.5 mm to 3.0 mm, and a thickness size of the both side ends in the width direction is in a range of 0.05 mm to 0.2 mm.

As the cross-sectional shape of the ribbon rubber 10, it is possible to employ various cross-sectional shapes in accordance with a shape of the rubber portion (tread rubber 7) to be formed. For example, the cross-sectional shape of the ribbon rubber 10 may be a trapezoidal shape or a flat-plate shape.

The forming device 70 changes the cross-sectional area of the ribbon rubber 10 to be wound by changing a tensile force to be applied to the ribbon rubber 10 for expanding the ribbon rubber 10. More specifically, the cross-sectional area of the ribbon rubber 10 is changed by changing rotation speed of the winding portion 72 and changing the tensile force to be applied to the ribbon rubber 10.

In this embodiment, the rotation speed of the winding portion 72 when the small portions 12 are formed is faster than that of the winding portion 72 when the standard portion 11 is formed. That is, the rotation speed of the winding portion 72 is set faster as the cross-sectional area of the ribbon rubber 10 to be formed is smaller. The small portions 12 are formed by expanding the ribbon rubber 10.

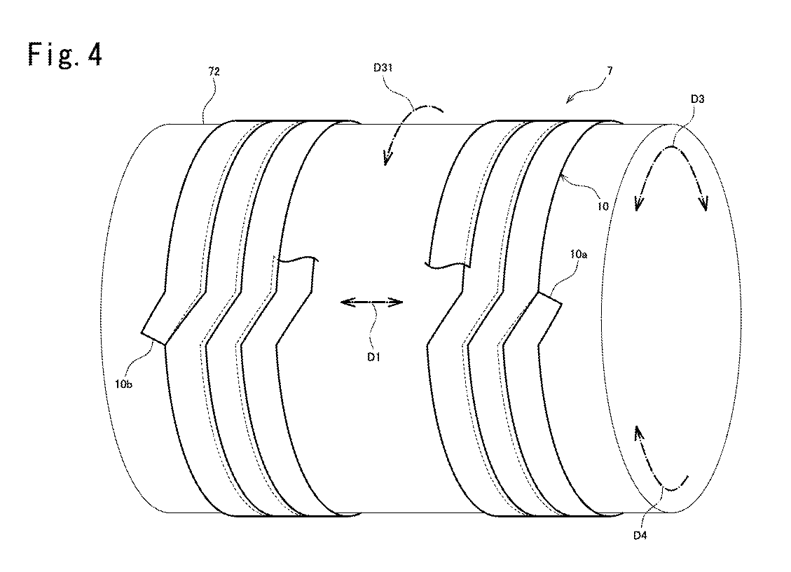

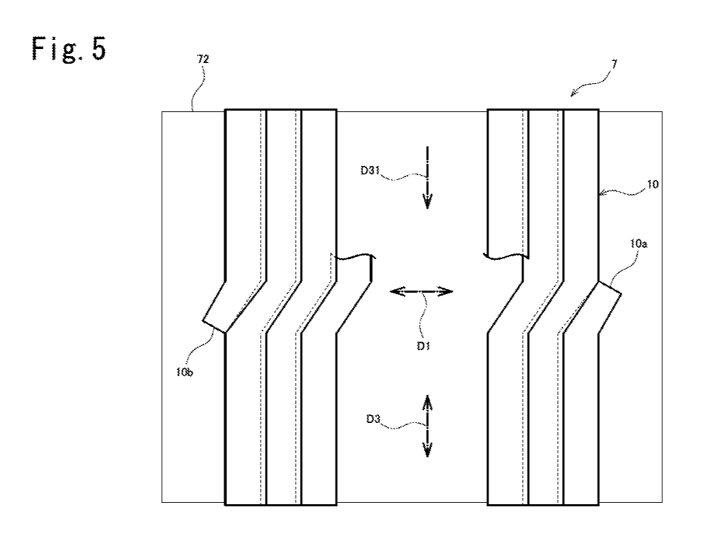

Next, the rubber portion (tread rubber 7) formed by the forming device 70 will be described with reference to FIGS. 4 and 5.

First, when a position of the winding portion 72 is fixed to the push-out portion 71, the ribbon rubber 10 is wound around the winding portion 72 such that the ribbon rubber 10 becomes parallel to the tire-circumferential direction D3. When the winding portion 72 moves in the axial direction (tire-width direction D1) of the winding portion 72 with respect to the push-out portion 71, the ribbon rubber 10 is wound around the winding portion 72 such that the ribbon rubber 10 intersects with the tire-circumferential direction D3 at a slant.

According to this, as shown in FIGS. 4 and 5, the ribbon rubber 10 is wound around the winding portion 72 such that a state where the ribbon rubber 10 becomes parallel to the tire-circumferential direction D3 and a state where the ribbon rubber 10 intersects with the tire-circumferential direction D3 at a slant are repeated. As a result, the ribbon rubber 10 is spirally wound along the tire-circumferential direction D3 such that the ribbon rubber 10 moves in the tire-width direction D1.

At this time, the ribbon rubber 10 is sent in the tire-width direction D1 at a predetermined pitch by winding the ribbon rubber 10 around the winding portion 72 such that the ribbon rubber 10 intersects with the tire-circumferential direction D3 at a slant. This pitch is set smaller than the width size of the ribbon rubber 10. According to this, the ribbon rubber sets 10 are superposed on each other in the tire-width direction D1. This superposed amount can be changed by changing a relative displacement amount between the push-out portion 71 and the winding portion 72 in the tire-width direction D1.

In this manner, the ribbon rubber 10 which is spirally wound along the tire-circumferential direction D3 is alternately provided with a parallel portion placed parallel to the tire-circumferential direction D3 and an inclined portion which is inclined with respect to the tire-circumferential direction D3 and placed between adjacent two rows in the tire-width direction D1. The inclination angle of the ribbon rubber 10 (inclined portion) with respect to the tire-circumferential direction D3 can be changed by changing rotation speed of the winding portion 72 or by changing the relative displacement speed between the push-out portion 71 and the winding portion 72 in the tire-width direction D1.

All of lengths of the inclined portions in the tire-circumferential direction D3 (ratios of inclined portions with respect to entire periphery of tire-circumferential direction D3) are set equal to each other. For example, the length of the inclined portion is set to a length of 1/18 periphery to 1/12 periphery (length in which rotation angle of winding portion 72 corresponds to 20° to 30°).

According to this, all of the inclination angles of the inclined portions with respect to the tire-circumferential direction D3 are set equal to each other. For example, the inclination angle is set to 45° or smaller. The lengths of the inclined portions in the tire-circumferential direction D3, and inclination angles of the inclined portions with respect to the tire-circumferential direction D3 may be different from each other.

In this embodiment, the first end 10a of the ribbon rubber 10, i.e., a winding-starting end (end which becomes starting point when ribbon rubber 10 is wound) 10a is located at an end on one side (right side in FIGS. 4 and 5) in the tire-width direction D1. The ribbon rubber 10 is spirally wound around the winding portion 72 such that the ribbon rubber 10 moves toward the other side (left side in FIG. 4 and 5) in the tire-width direction D1. The second end 10b of the ribbon rubber 10, i.e., a winding-finishing end (end which becomes completion point when ribbon rubber 10 is wound) is located on the other end in the tire-width direction D1.

Therefore, in this embodiment, the ribbon rubber 10 is spirally wound around the winding portion 72 such that a moving direction of the ribbon rubber 10 in the tire-width direction D1 becomes one direction (left side in FIGS. 4 and 5). The winding method of the ribbon rubber 10 is not limited to this method. For example, the ribbon rubber 10 may be spirally wound around the winding portion 72 such that the ribbon rubber 10 is folded back at the end of the rubber portion (tread rubber 7) in the tire-width direction D1, and the moving direction in the tire-width direction D1 is changed from one side to the other side.

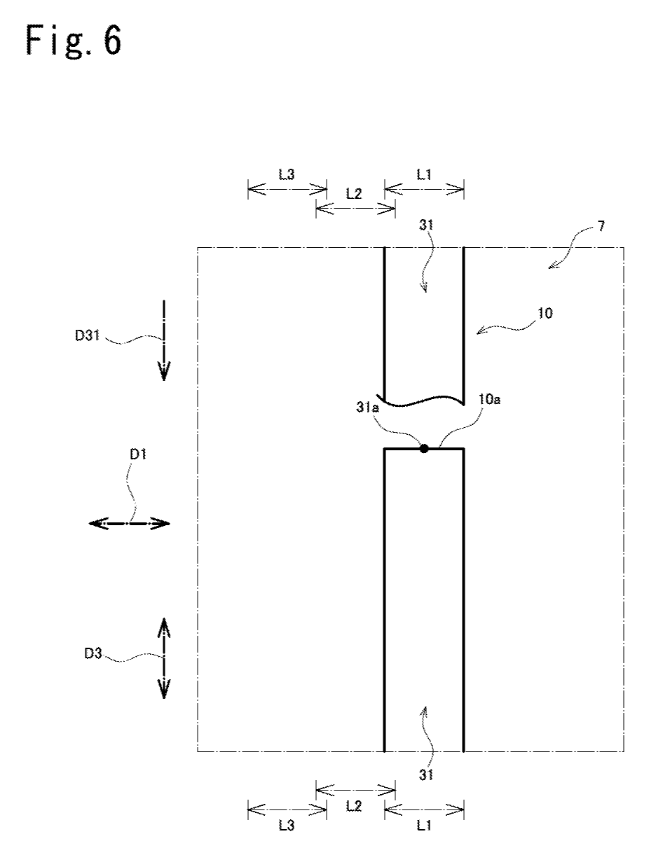

Next, the wound state of the ribbon rubber 10 in the rubber portion (tread rubber 7) will be described with reference to FIGS. 6 to 11 while comparing with a comparative example.

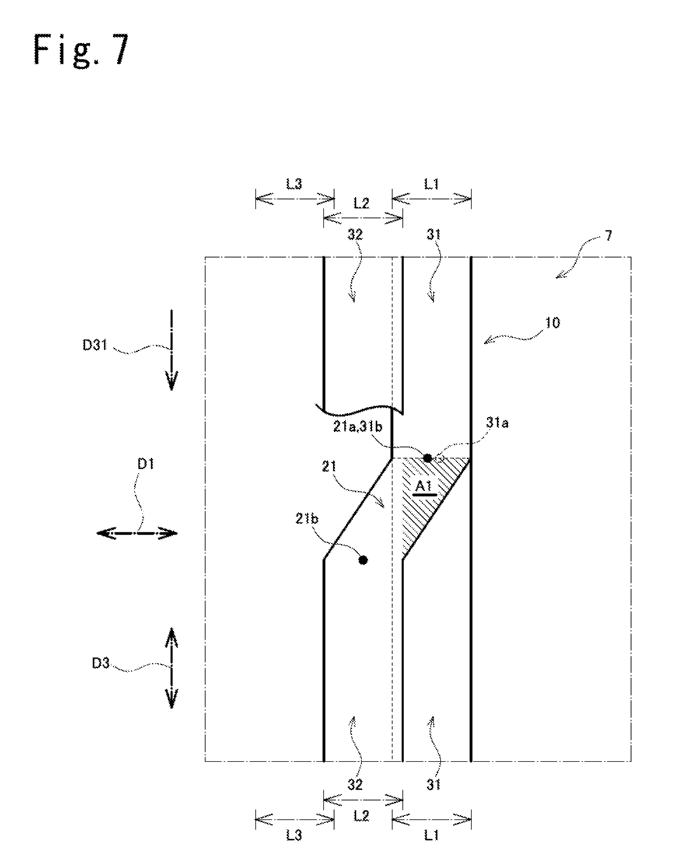

First, a wound state of a portion of the ribbon rubber 10 of the comparative example close to a winding-starting end 10a will be described with reference to FIGS. 6 and 7.

As shown in FIG. 6, in the tread rubber 7 of the comparative example, the winding-starting end 10a of the ribbon rubber 10 is located in an outer first row L1. The ribbon rubber 10 of the comparative example has a uniform cross-sectional area over its entire length. The ribbon rubber 10 is wound parallel to the tire-circumferential direction D3 in the outer first row L1. According to this, a first parallel portion 31 is placed parallel to the tire-circumferential direction D3.

As shown in FIG. 7, the ribbon rubber 10 is wound at a slant with respect to the tire-circumferential direction D3 such that the ribbon rubber 10 moves from the outer first row L1 toward an outer second row L2. According to this, a first inclined portion 21 is placed at a slant with respect to the tire-circumferential direction D3 such that the first inclined portion 21 moves from the outer first row L1 toward the outer second row L2 in the winding direction D31.

At this time, a winding-finishing end 31b of the first parallel portion 31 (winding-starting end 21a of first inclined portion 21) is located at the same position as a winding-starting end 31a of the first parallel portion 31 in the tire-circumferential direction D3. Thereafter, the ribbon rubber 10 is wound parallel to the tire-circumferential direction D3 in the outer second row L2. According to this, a second parallel portion 32 is placed parallel to the tire-circumferential direction D3.

As described above, in the tread rubber 7 of the comparative example, the outer first row L1 is configured by the first parallel portion 31 and a portion of the first inclined portion 21 close to the winding-starting end 21a. According to this, in the outer first row L1, the first parallel portion 31 and the portion of the first inclined portion 21 close to the winding-starting end 21a are superposed on each other, and this configuration generates a rubber-surplus portion (inclined line region A1 in FIG. 7). Therefore, a rubber weight of the outer first row L1 becomes non-uniform in the tire-circumferential direction D3.

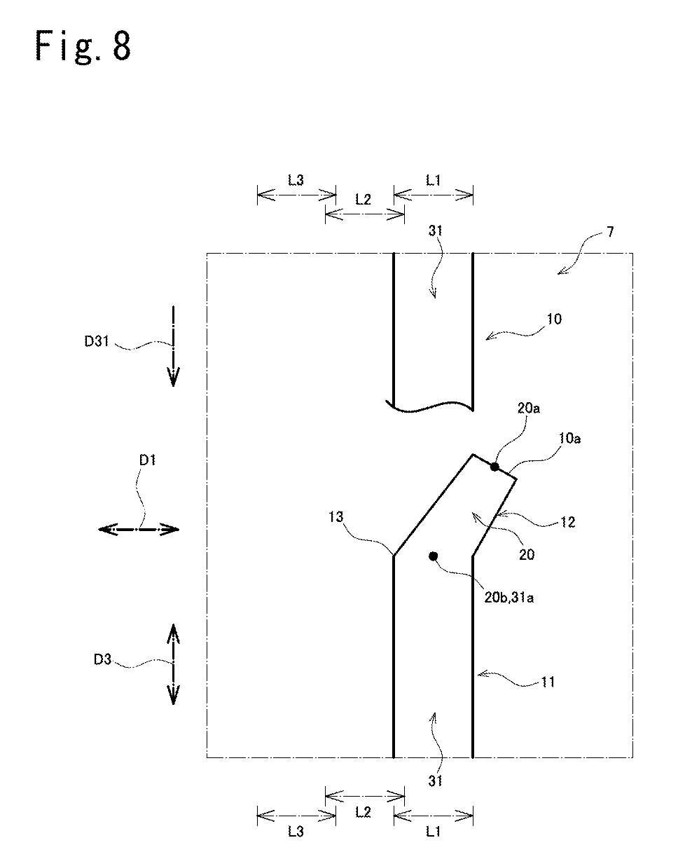

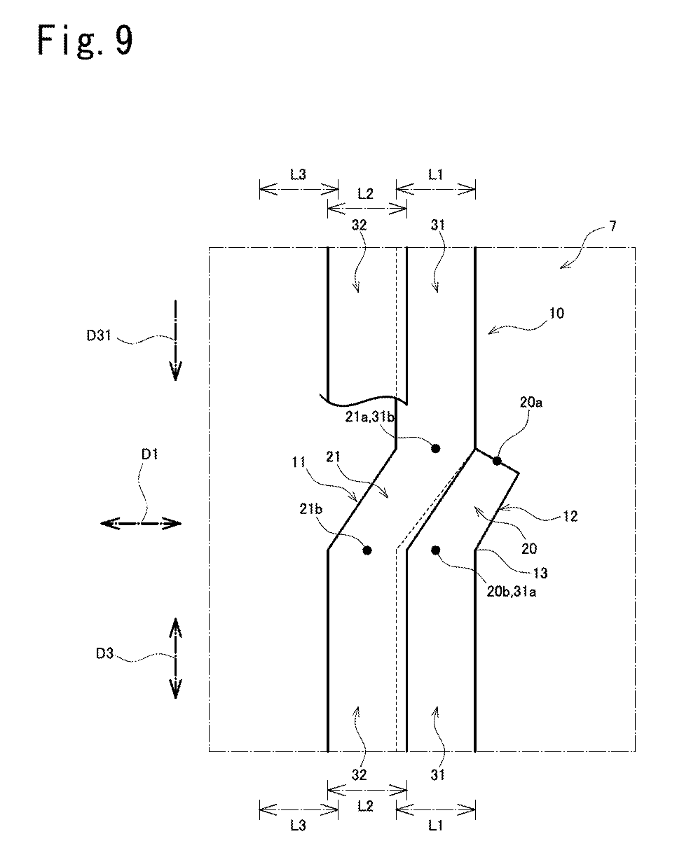

Next, a wound state of a portion of the ribbon rubber 10 of this embodiment close to the winding-starting end 10a will be described with reference to FIGS. 8 and 9.

As shown in FIG. 3, in the tread rubber 7 of this embodiment. the winding-starting end 10a of the ribbon rubber 10 is located outside of the outer first row L1 in the tire-width direction D1 (right side in FIG. 8). The ribbon rubber 10 is wound at a slant with respect to the tire-circumferential direction D3 such that the ribbon rubber 10 moves from a location outside of the outer first row L1 toward the outer first row L1. According to this, an outermost inclined portion 20 is placed at a slant with respect to the tire-circumferential direction D3 from a location outside of the outer first row L1 toward the outer first row L1 in the winding direction D31.

The ribbon rubber 10 is wound parallel to the tire-circumferential direction D3 in the outer first row L1. According to this, the first parallel portion 31 is placed parallel to the tire-circumferential direction D3. A cross-sectional area of the outermost inclined portion 20 is smaller than that of the first parallel portion 31. More specifically, a boundary position 13 is a connection position between the outermost inclined portion 20 and the first parallel portion 31. According to this, the outermost inclined portion 20 is configured by a small portion 12, and the first parallel portion 31 is configured by a standard portion 11 of the ribbon rubber 10.

The cross-sectional area of the outermost inclined portion 20 gradually becomes larger from a location outside of the outer first row L1 toward the outer first row L1. That is, the cross-sectional area of the outermost inclined portion 20 gradually becomes larger from a winding-starting end 20a toward a winding-finishing end 20b.

As shown in FIG. 9, the ribbon rubber 10 is wound at a slant with respect to the tire-circumferential direction D3 such that the ribbon rubber 10 moves from the outer first row LI toward the outer second row L2. According to this, the first inclined portion 21 is placed at a slant with respect to the tire-circumferential direction D3 such that the first inclined portion 21 moves from the outer first row L1 toward the outer second row L2 in the winding direction D31.

At this time, the winding-starting end 21a of the first inclined portion 21 (winding-finishing end 31b of first parallel portion 31) is located at the same position as the winding-starting end 20a of the outermost inclined portion 20 in the tire-circumferential direction D3. Further, the winding-finishing end 21b of the first inclined portion 21 is located at the same position as the winding-finishing end 20b of the outermost inclined portion 20 (winding-starting end 31a of first parallel portion 31) in the tire-circumferential direction D3. According to this, the outermost inclined portion 20 is placed along the first inclined portion 21.

As described above, in the tread rubber 7 of this embodiment, the outer first row L1 is configured by a portion of the outermost inclined portion 20 close to the winding-finishing end 20b, the first parallel portion 31, and a portion of the first inclined portion 21 close to the winding-starting end 21a. According to this, it is possible to restrain a rubber-surplus portion from being generated in the outer first row L1. Therefore, it is possible to restrain a rubber weight of the outer first row L1 from becoming non-uniform in the tire-circumferential direction D3.

Thereafter, the ribbon rubber 10 is wound parallel to the tire-circumferential direction D3 in the outer second row L2. According to this, the second parallel portion 32 is placed parallel to the tire-circumferential direction D3. Thereafter, the ribbon rubber 10 is switched between a state where it is wound at a slant with respect to the tire-circumferential direction D3 and a state where it is wound parallel to the tire-circumferential direction D3 at the same position in the tire-circumferential direction D3.

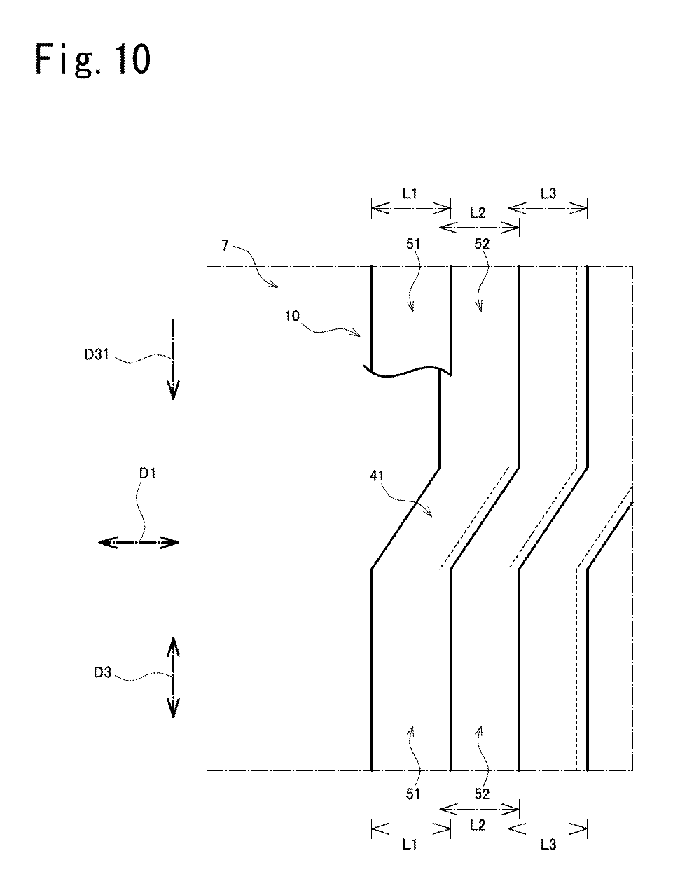

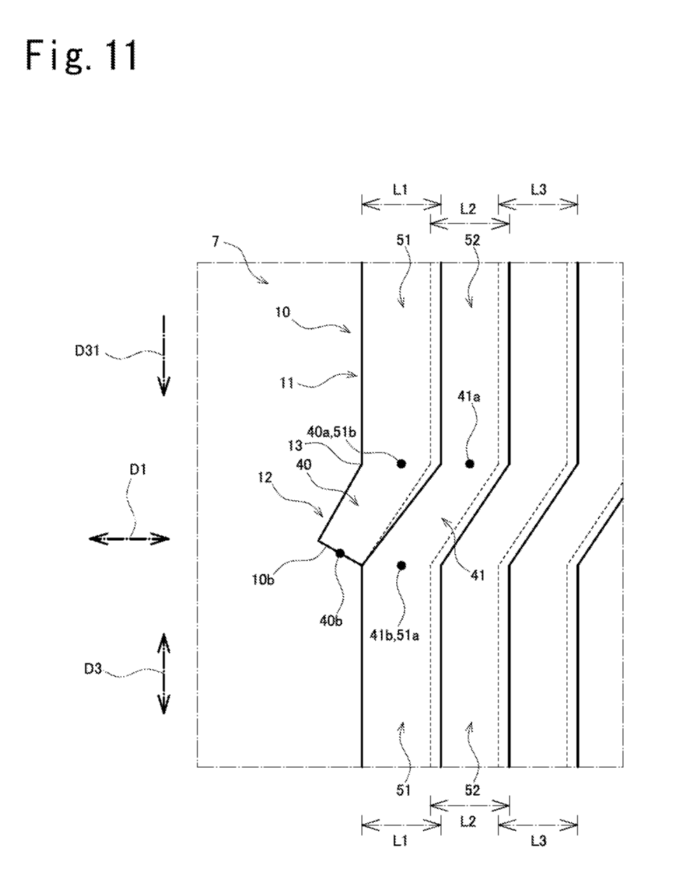

Next, a wound state of a portion of the ribbon rubber 10 of this embodiment close to the winding-finishing end 10b will be described with reference to FIGS. 10 and 11.

As shown in FIG. 10, in the tread rubber 7 of this embodiment, the state where the ribbon rubber 10 is wound parallel to the tire-circumferential direction D3 and the state where the ribbon rubber 10 is wound at a slant with respect to the tire-circumferential direction D3 are switched from the inner side in the tire-width direction D1 to the outer second row L2 at the same position in the tire-circumferential direction D3. In the outer second row L2, the ribbon rubber 10 is wound parallel to the tire-circumferential direction D3. According to this, second parallel portions 52 are placed parallel to the tire-circumferential direction D3.

Thereafter, the ribbon rubber 10 is wound at a slant with respect to the tire-circumferential direction D3 from the outer second row L2 toward the outer first row L1. According to this, a first inclined portion 41 is placed at a slant with respect to the tire-circumferential direction D3 from the outer second row L2 toward the outer first row L1 in the winding direction D31. The ribbon rubber 10 is wound parallel to the tire-circumferential direction D3 in the outer first row L1. According to this, a first parallel portion 51 is placed parallel to the tire-circumferential direction D3.

As shown in FIG. 11, the ribbon rubber 10 is wound at a slant with respect to the tire-circumferential direction D3 from the outer first row L1 toward a location outside of the outer first row L1 (left side in FIG. 11). According to this, an outermost inclined portion 40 is placed at a slant with respect to the tire-circumferential direction D3 from the outer first row L1 toward a location outside of the outer first row L1 in the winding direction D31. Therefore, the winding-finishing end 10b of the ribbon rubber 10 is located at a position outside of the outer first row L1 in the tire-width direction D1.

A cross-sectional area of the outermost inclined portion 40 is smaller than that of the first parallel portion 51. More specifically, the boundary position 13 is a connection position between the outermost inclined portion 40 and the first parallel portion 51, the outermost inclined portion 40 is configured by the small portion 12 of the ribbon rubber 10, and the first parallel portion 51 is configured by the standard portion 11 of the ribbon rubber 10.

The cross-sectional area of the outermost inclined portion 40 gradually becomes larger from a location outside of the outer first row L1 toward the outer first row L1. That is, the cross-sectional area of the outermost inclined portion 40 gradually becomes larger from a winding-finishing end 40b toward a winding-starting end 40a.

The winding-starting end 40a of the outermost inclined portion 40 (winding-finishing end 51b of first parallel portion 51) is located at the same position as a winding-starting end 41a of the first inclined portion 41. The winding-finishing end 40b of the outermost inclined portion 40 is located at the same position as a winding-finishing end 41b of the first inclined portion 41 (winding-starting end 51a of first parallel portion 51) in the tire-circumferential direction D3. According to this, the outermost inclined portion 40 is placed along the first inclined portion 41.

As described above, an the tread rubber 7 of this embodiment, the outer first row L1 is configured by a portion of the first inclined portion 41 close to the winding-finishing end 41b and a portion of the outermost inclined portion 40 close to the winding-starting end 40a. According to this, it is possible to further restrain a rubber-surplus portion from being generated in the outer first row L1 as compared with a configuration that the winding-finishing end 10b of the ribbon rubber 10 is located at the outer first row L1. Therefore, it is possible to restrain a rubber weight of the outer first row L1 from becoming non-uniform in the tire-circumferential direction D3.

The tire 1 of this embodiment includes the rubber portion (tread rubber 7 in this embodiment)formed from ribbon rubber 10 which is spirally wound along the tire-circumferential direction D3. The ribbon rubber 10 includes the first inclined portion 21, 41 which is placed at a slant with respect to the tire-circumferential direction D3 from the outer second row L2 of the tire-width direction D1 to the outer first row L1, the first parallel portion 31, 51 having the end 31b, 51a connected to the end 21a, 41b of the first inclined portion 21, 41, the first parallel portion 31, 51 being placed parallel to the tire-circumferential direction D3 to configure the outer first row L1 of the tire-width direction D1, and the outermost inclined portion 20, 40 having the end 20b, 40a connected to the end 31a, 51b of the first parallel portion 31, 51, the outermost inclined portion 20, 40 being placed at a slant with respect to the tire-circumferential direction D3. The outermost inclined portion 20,40 is placed along the first inclined portion 21, 41, and is placed outside of the outer first row L1 from the outer first row L1 of the tire-width direction D1.

According to this configuration, the first inclined portions 21, 41 are placed at a slant with respect to the tire-circumferential direction D3 from the outer second row L2 to the outer first row L1 of the tire-width direction D1. Ends 31b, 51a of the first parallel portions 31, 51 are connected to ends 21a, 41b of the first inclined portions 21, 41, and the first parallel portions 31, 51 are placed parallel to the tire-circumferential direction D3 to configure the outer first row L1 of the tire-width direction D1.

Ends 20b, 40a of the outermost inclined portions 20, 40 are connected to ends 31a, 51b of the first parallel portions 31, 51, and are placed at a slant with respect to the tire-circumferential direction D3. The outermost inclined portions 20, 40 are placed along the first inclined portions 21, 41, and are placed from the outer first row L1 to a location outside of the outer first row L1 of the tire-width direction D1.

According to this, the outer first row L1 of the tire-width direction D1 is configured by portions (close to ends 20b, 40a) of the outermost inclined portions 20, 40, and portions of the first inclined portions 21, 41 (close to ends 21a, 41b). Therefore, as compared with a configuration that the ends 10a, 10b of the ribbon rubber 10 are located in the outer first row L1 of the tire-width direction D1, it is possible to further restrain a rubber weight of the outer first row Li of the tire-width direction D1 from becoming non-uniform in the tire-circumferential direction D3.

As a result, it is possible to restrain RFV (Radial Force Variation) from becoming large in the tire 1 having the rubber portion (tread rubber 7 in this embodiment). Further, by reducing a region where the ribbon rubber sets 10 are superposed on each other, it is possible to restrain the rubber size from becoming thick. According to this, by improving heat radiating properties, it is possible to improve high-speed durability.

In the tire 1 of this embodiment, the cross-sectional area of the outermost inclined portion 20, 40 is smaller than the cross-sectional area of the first parallel portion 31, 51.

According to this configuration, since the cross-sectional areas of the outermost inclined portions 20, 40 are smaller than those of the first parallel portions 31, 51, it is possible to restrain a rubber weight at a location outside of the outer first row L1 of the tire-width direction D1 from increasing. According to this, it is possible to restrain the rubber weight from becoming non-uniform in a region outside of the outer first row L1 of the tire-width direction D1 of the tire 1, As a result, in the tire 1 having the rubber portion (tread rubber 7 in this embodiment), it is possible to effectively restrain RFV from becoming large.

In the tire 1 of this embodiment, the outermost inclined portion 20 is placed at a slant with respect to the tire-circumferential direction D3 from outside of the outer first row L1 of the tire-width direction D1 toward the outer first row L1 in a winding direction D31. The winding-starting end 31a of the first parallel portion 31 is connected to the winding-finishing end 20b of the outermost inclined portion 20. The first parallel portion 31 is placed parallel to the tire-circumferential direction D3 to configure the outer first row L1 of the tire-width direction D1. The winding-starting end 21a of the first inclined portion 21 is connected to the winding-finishing end 31b of the first parallel portion 31. The first inclined portion 21 is placed at a slant with respect to the tire-circumferential direction D3 from the outer first row L1 of the tire-width direction D1 toward an outer second row L2 in the winding direction D31.

According to this configuration, the outermost inclined portion 20 is placed along the first inclined portion 21, and is placed in the outer first row L1 from a location outside of the outer first row L1 of the tire-width direction D1 in the winding direction D31. According to this, it is possible to restrain a rubber weight of the outer first row L1 close to the winding-starting end 10a of the ribbon rubber 10 from becoming non-uniform in the tire-circumferential direction D3.

In the tire 1 of this embodiment, the first inclined portion 41 is placed at a slant with respect to the tire-circumferential direction D3 from the outer second row L2 of the tire-width direction D1 toward the outer first row L1 in the winding direction D31. The winding-starting end 51a of the first parallel portion 51 is connected to a winding-finishing end 41b of the first inclined portion 41. The first parallel portion 51 is placed parallel to the tire-circumferential direction D3 to configure the outer first row L1 of the tire-width direction D1. The winding-starting end 40a of the outermost inclined portion 40 is connected to a winding-finishing end 51b of the first parallel portion 51. The outermost inclined portion 40 is placed at a slant with respect to the tire-circumferential direction D3 from the outer first row L1 of the tire-width direction D1 toward outside of the outer first row L1 in the winding direction D31.

According to this configuration, the outermost inclined portion 40 is placed along the first inclined portion 41, and is placed from the outer first row L1 of the tire-width direction D1 in the winding direction D31 at a location outside of the outer first row L1. According to this, it is possible to restrain a rubber weight of the outer first row L1 close to the winding-starting end 10a of the ribbon rubber 10 from becoming non-uniform in the tire-circumferential direction D3.

In the manufacturing method of tire 1 of this embodiment, the tire 1 including the rubber portion (tread rubber 7 in this embodiment) formed from ribbon rubber 10 which is spirally wound along the tire-circumferential direction D3. The method includes pushing out rubber to form the ribbon rubber 10 having a uniform cross-sectional shape, winding the ribbon rubber 10 around the rotating winding portion 72, and changing a cross-sectional area of the wound ribbon rubber 10 by changing a tensile force to be applied to the ribbon rubber 10 for expanding the ribbon rubber 10.

According to this method, the ribbon rubber 10 having the uniform cross-sectional shape is formed by pushing out rubber, and the pushed out and formed ribbon rubber 10 is wound around the rotating winding portion 12. According to this, it is possible to manufacture the tire 1 having the rubber portion (tread rubber 7 in this embodiment) formed from the ribbon rubber 10 which is spirally wound along the tire-circumferential direction D3.

By changing a tensile force applied to the ribbon rubber 10 to expand the ribbon rubber 10, a cross-sectional area of the ribbon rubber 10 to be wound is changed. According to this, by changing the cross-sectional area of the ribbon rubber 10 in accordance with a shape of a rubber portion to be formed, it is possible to restrain a rubber weight from becoming non-uniform.

In the manufacturing method of tire 1 of this embodiment, rotation speed of the winding portion 72 is changed in order to change the tensile force to be applied to the ribbon rubber 10.

According to this method, it is possible to change a tensile force to be applied to the ribbon rubber 10 by changing rotation speed of the winding portion 72. According to this, it is possible to easily change the cross-sectional area of the ribbon rubber 10 to be wound.

The tire is not limited to the configuration and effect of the tire 1 of the first embodiment. For example, the tire 1 of the first embodiment may be changed in the following manners.

The tire 1 of the first embodiment has the configuration that the outermost inclined portions 20, 40 are provided on both the side of the winding-starting end 10a and the side of the winding-finishing end 10b of the ribbon rubber 10. However, the tire is not limited to this configuration. In the tire, for example, the outermost inclined portions 20, 40 may be provided only on one of the side of the winding-starting end 10a and the side of the winding-finishing end 10b of the ribbon rubber 10. That is, it is only necessary that at least one of the ends 10a, 10b of the ribbon rubber 10 is placed on the end of the rubber portion (tread rubber 7) of the tire-width direction D1.

Further, in the tire 1 of the first embodiment, the cross-sectional areas of the outermost inclined portions 20, 40 are smaller than those of the first parallel portions 31, 51. However, the tire is not limited to this configuration. For example, in the tire, the cross-sectional areas of the outermost inclined portions 20, 40 may be the same as those of the first parallel portions 31, 51. That is, in the tire, the cross-sectional area of the ribbon rubber 10 may be uniform over its entire length.

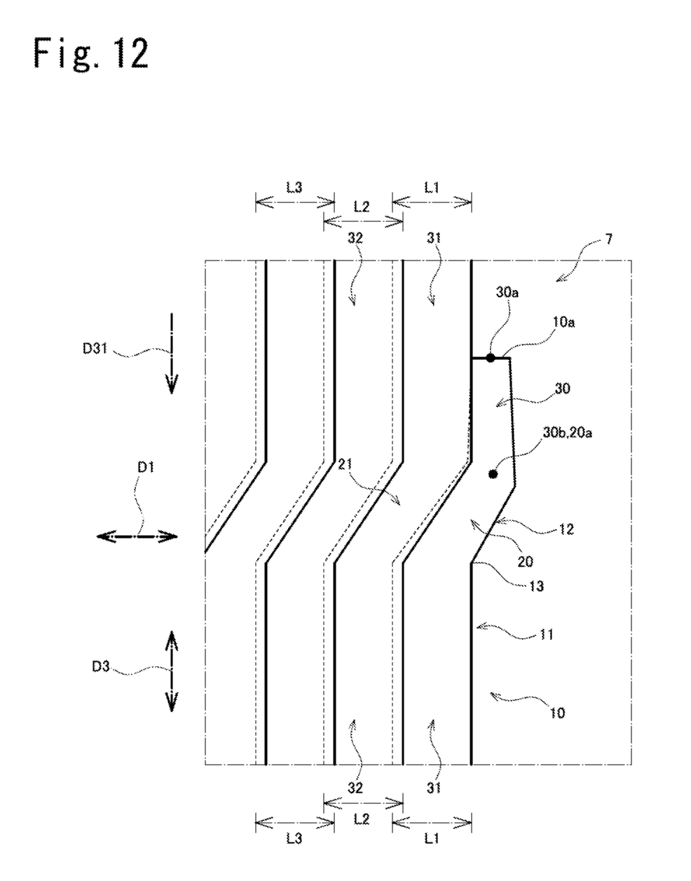

Furthermore, in the tire 1 of the first embodiment, the ends 10a, 10b of the ribbon rubber 10 are the ends 20a, 40b of the outermost inclined portions 20, 40. However, the tire is not limited to this configuration. In the tire, for example. as shown in FIG. 12, the ribbon rubber 10 may include an outermost parallel portion 30 which is placed on the location outside of the outer first row L1 of the tire-width direction D1 and parallel to the tire-circumferential direction D3, and the end 10a of the ribbon rubber 10 may be an end 30a of the outermost parallel portion 30.

In FIG. 12, the first end (winding-starting end) 30a of the outermost parallel portion 30 is an end (winding-end) 10a of the ribbon rubber 10, and the second end (winding-finishing end) 30b of the outermost parallel portion 30 is connected to an end (winding-starting end) 20a of the outermost inclined portion 20. Although the winding-starting end 10a of the ribbon rubber 10 is described in FIG. 12, the ribbon rubber 10 may include an outermost parallel portion close to the winding-finishing end 10b.

### Second Embodiment

Next, a second embodiment in the tire will be described with reference to FIGS. 13 to 20. In FIGS. 13 to 20, elements to which the same reference signs as those of FIGS. 1 to 12 are denoted have substantially the same configurations or functions (effects) as the first embodiment, and description thereof will not be repeated.

The tire 1 of this embodiment has configurations 2 to 8 as the tire 1 of the first embodiment (see FIGS. 1 to 3), and the tire 1 includes a rubber portion (tread rubber 7 also in this embodiment) formed from ribbon rubber which is spirally wound along the tire-circumferential direction D3 around a rotation axis of the tire. The ribbon rubber 10 and the forming device 70 of this embodiment are substantially the same as those of the first embodiment.

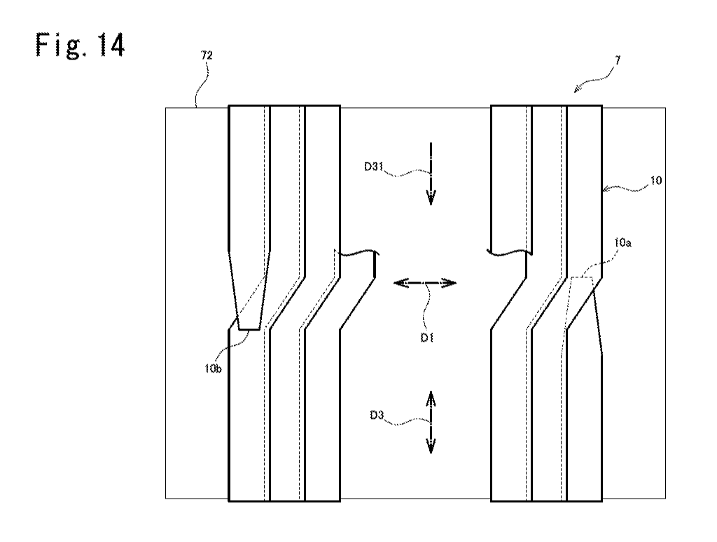

The rubber portion (tread rubber 7) formed by the forming device 70 is shown in FIGS. 13 and 14. A configuration and a method for spirally winding the ribbon rubber 10 along the tire-circumferential direction D3 are substantially the same as those of the first embodiment (see FIGS. 4 and 5).

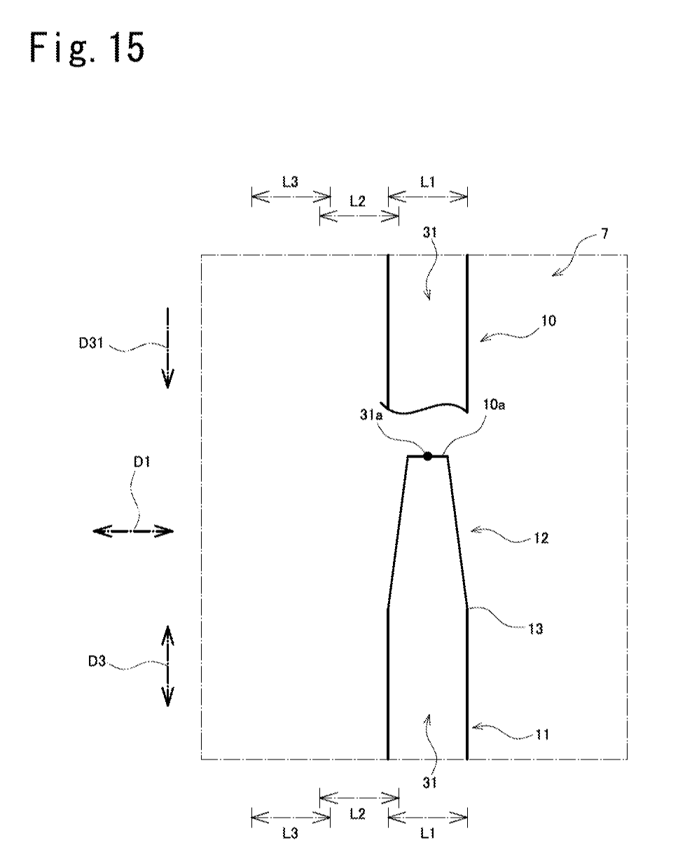

Next, a wound state of the ribbon rubber 10 in the rubber portion (tread rubber 7) will be described with reference to FIGS. 15 to 20 while comparing with a comparative example. Note that a tread rubber 7 of the comparative example is the same as the tread rubber 7 of the comparative example in the first embodiment (see FIGS. 6 and 7). That is, in the comparative example, since a rubber-surplus portion (inclined line region A1 in FIG. 7) is generated in the outer first row L1, a rubber weight of the outer first row L1 becomes non-uniform in the tire-circumferential direction D3.

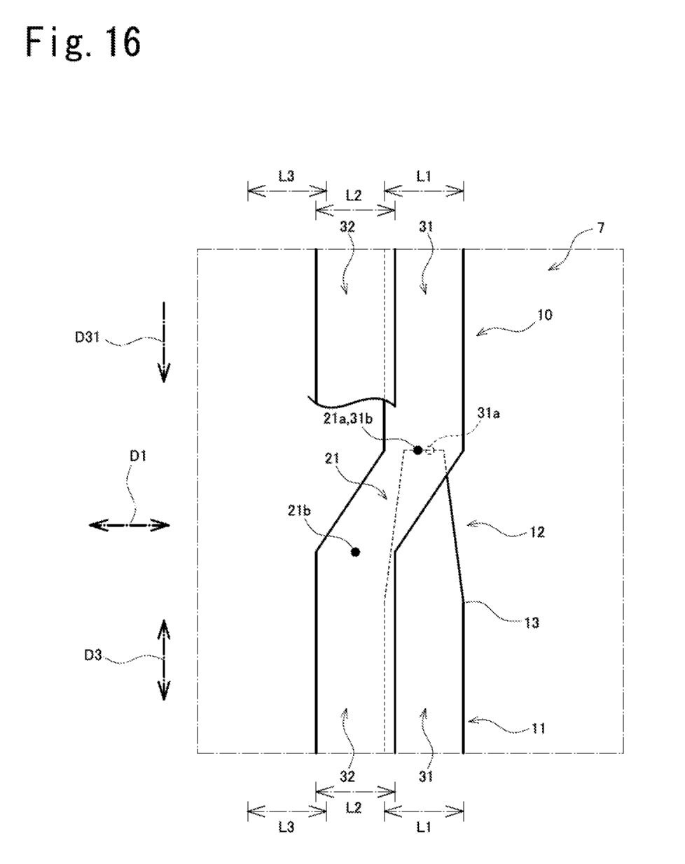

First, a wound state of a portion of the ribbon rubber 10 of this embodiment close to the winding-starting end 10a will be described with reference to FIGS. 15 and 16.

As shown in FIG. 15, in the tread rubber 7 of this embodiment, the winding-starting end 10a of the ribbon robber 10 is located in the outer first row L1. The ribbon rubber 10 is wound parallel to the tire-circumferential direction D3 in the outer first row L1. According to this, the first parallel portion 31 is placed parallel to the tire-circumferential direction D3.

A portion of the first parallel portion 31 close to the winding-starting end 31a is configured by the small portion 12. More specifically, a portion the first parallel portion 31 located opposite from the winding direction D31 than a predetermined boundary position 13 is configured by the small portion 12, and a portion of the first parallel portion 31 closer to the winding direction D31 than the predetermined boundary position 13 is configured by the standard portion 11. A cross-sectional area of the first parallel portion 31 gradually becomes larger from the winding-starting end 31a toward the boundary position 13.

As shown in FIG. 16, the ribbon rubber 10 is wound at a slant with respect to the tire-circumferential direction D3 such that the ribbon rubber 10 moves from the outer first row L1 toward the outer second row L2. According to this, the first inclined portion 21 is placed at a slant with respect to the tire-circumferential direction D3 such that the first inclined portion 21 moves from the outer first row L1 toward the outer second row L2 in the winding direction D31.

At this time, the winding-finishing end 31b of the first parallel portion 31 (winding-starting end 21a of first inclined portion 21) is located at the same position as the winding-starting end 31a of the first parallel portion 31 in the tire-circumferential direction D3. Note that the expression “the same position (in tire-circumferential direction D3)” not only includes completely the same position but also includes substantially the same position.

The winding-finishing end 21b of the first inclined portion 21 is located on a side opposite from the winding direction D31 than the boundary position 13 between the standard portion 11 and the small portion 12. According to this, a length of the first inclined portion 21 in the tire-circumferential direction D3 is shorter than a length of the small portion 12 in the tire-circumferential direction D3. A portion of the first inclined portion 21 (close to winding-starting end 21a) is superposed on a portion of the small portion 12 of the first parallel portion 31 such that the portion of the first inclined portion 21 covers the portion of the small portion 12 from outside in a tire-radial direction D2.

Thereafter, the ribbon rubber 10 is wound parallel to the tire-circumferential direction D3 in the outer second row L2. According to this, the second parallel portion 32 is placed parallel to the tire-circumferential direction D3. Further, thereafter, the ribbon rubber 10 is switched between a state where it is wound at a slant with respect to the tire-circumferential direction D3 and a state where it is wound parallel to the tire-circumferential direction D3 at the same position in the tire-circumferential direction D3.

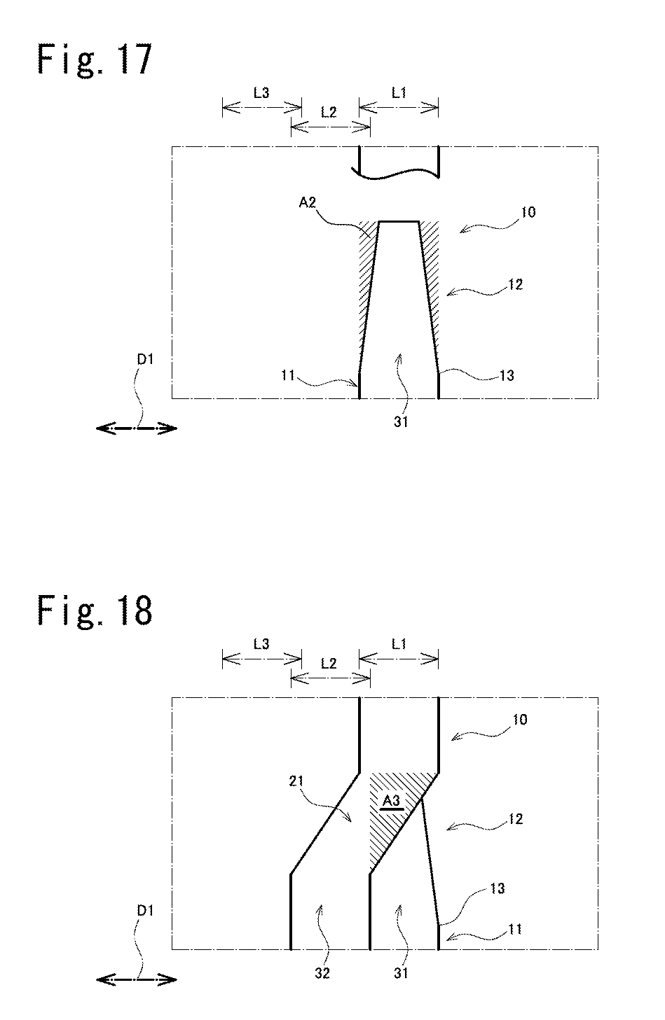

The outer first row L1 of one end of the tread rubber 7 is configured by the first parallel portion 31 and a portion of the first inclined portion 21 close to the winding-starting end 21a. In the meantime, in the small portion 12, as shown in FIG. 17, a rubber-insufficient portion (inclined line region A2 in FIG. 17) is generated as compared with the standard portion 11 having the same length. FIG. 17 only shows, with the inclined line region, the rubber-insufficient portion in the tire-width direction D1 caused due to a fact that a width of the ribbon rubber 10 is narrow, and does not show a rubber-insufficient portion in the tire-radial direction D2 caused due to a fact that a thickness of the ribbon rubber 10 is thin.

Hence, as shown in FIG. 13, a rubber volume at a location (inclined line region A3 in FIG. 18) where the first inclined portion 21 is located in the outer first row L1 is the same as a rubber volume of a rubber-insufficient portion caused due to the small portion 12. According to this, the tread rubber 7 of this embodiment can restrain a rubber weight in the outer first row L1 from becoming non-uniform in the tire-circumferential direction D3 as compared with a comparative example which is configured by ribbon rubber 10 having a uniform cross-sectional area over its entire length.

Note that, the expression that “(rubber volume) is the same” not only includes completely the same but also includes substantially the same (e.g., ±10%). Further, “rubber volume at a location where an inclined portion is located in a predetermined row (outer first row L1)” means a rubber volume at a location where an inclined portion is located only in a predetermined row L1, and this expression excludes a rubber volume at a location where an inclined portion is located in both of the predetermined row L1 and an adjacent row L2 (i.e., a location where the ribbon rubber sets 10 are superposed by pitch sending).

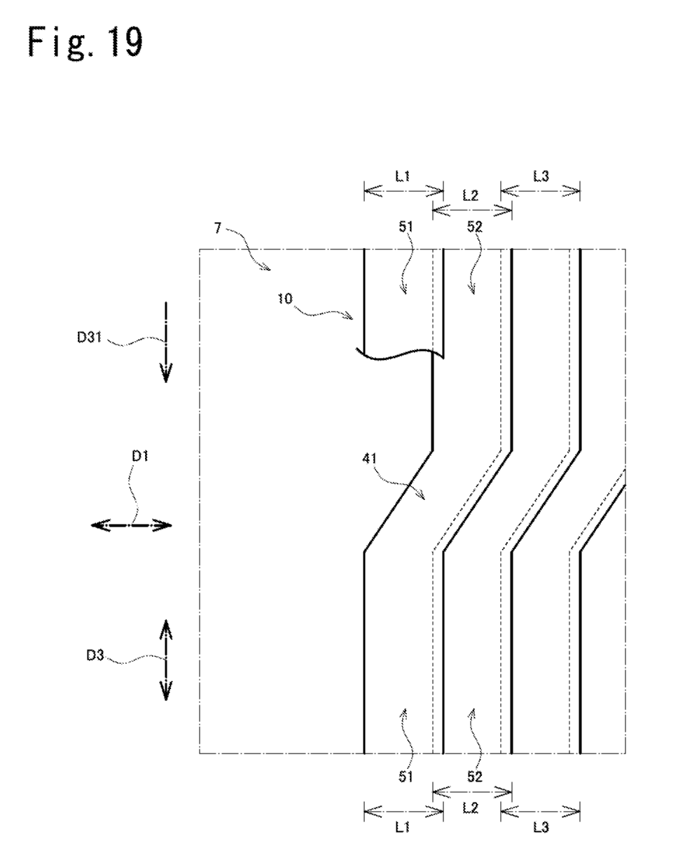

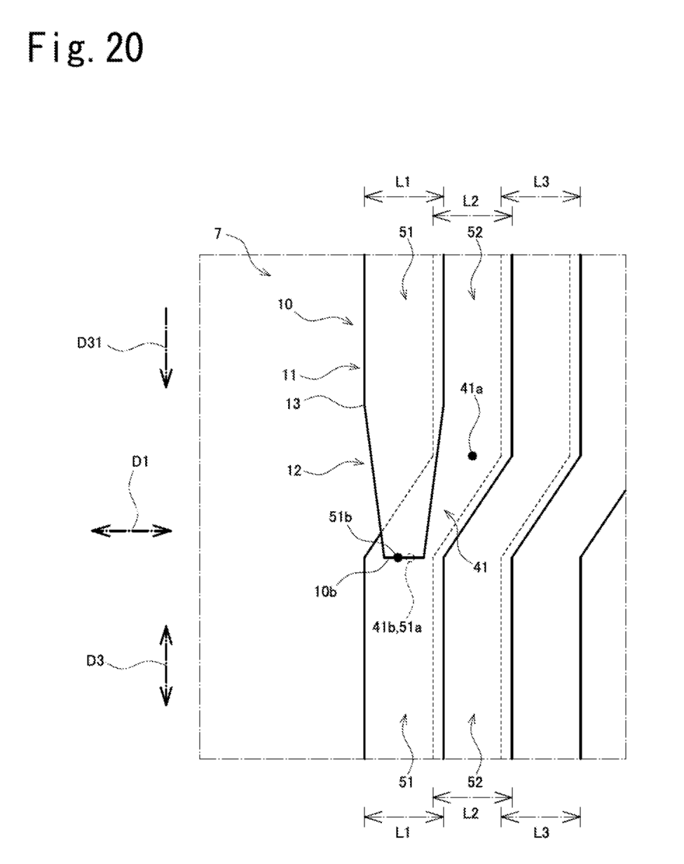

Next, a wound state of a portion of the ribbon rubber 10 of this embodiment close to the winding-finishing end 10b will be described with reference to FIGS. 19 and 20.

As shown in FIG. 19, in the tread rubber 7 of this embodiment, from inside of the tire-width direction D1 to the outer second row L2, the ribbon rubber 10 is switched between a state where it is wound parallel to the tire-circumferential direction D3 and a state where it is wound at a slant with respect to the tire-circumferential direction D3 at the same position in the tire-circumferential direction D3. The ribbon rubber 10 is wound parallel to the tire-circumferential direction D3 in the outer second row L2. According to this, the second parallel portions 52 are placed parallel to the tire-circumferential direction D3.

Thereafter, the ribbon rubber 10 is wound at a slant with respect to the tire-circumferential direction D3 from the cuter second row L2 toward the outer first row L1. According to this, the first inclined portion 41 is placed at a slant with respect to the tire-circumferential direction D3 from the outer second row L2 toward the outer first row L1 in the winding direction D31. The ribbon rubber 10 is wound parallel to the tire-circumferential direction D3 in the outer first row L1. According to this, the first parallel portion 51 is placed parallel to the tire-circumferential direction D3.

As shown in FIG. 20, the winding-finishing end 51b of the first parallel portion 51 is located at the same position as the winding-starting end 51a of the first parallel portion 51 (winding-finishing end 41b of first inclined portion 41) in the tire-circumferential direction D3. The winding-starting end 41a of the first inclined portion 41 is located closer to the winding direction D31 than the boundary position 13 between the standard portion 11 and the snail portion 12. In the tread rubber 7 of this embodiment, the winding-finishing end 10b of the ribbon rubber 10 is located in the outer first row L1.

According to this, a length of the small portion 12 in the tire-circumferential direction D3 is longer than that of the first inclined portion 41 in the tire-circumferential direction D3. A portion of the first inclined portion 41 (close to winding-finishing end 41b) is superposed on a portion of the small portion 12 of the first parallel portion 51 such that the portion of the first inclined portion 41 covers the portion of the small portion 12 from outside in a tire-radial direction D2.

As described above, the outer first row L1 close to the other end of the tread rubber 7 is configured by a portion of the winding-finishing end 41b of the first inclined portion 41 and the first parallel portion 51. In the small portion 12, a rubber-insufficient portion caused due to a fact that a width and a thickness of the small portion 12 are smaller than those of the standard portion 11 having the same length is generated.

A rubber volume at a location where the first inclined portion 41 is located in the outer first row L1 is the same as that of the rubber-insufficient portion caused due to the small portion 12. According to this, the tread rubber 7 of this embodiment can restrain a rubber weight from becoming non-uniform in the tire-circumferential direction D3 in the outer first row L1 as compared with the comparative example which is configured by the ribbon rubber 10 having a uniform cross-sectional area over its entire length.

The tire 1 of this embodiment includes the rubber portion (tread rubber 7 in this embodiment) formed from ribbon rubber 10 which is spirally wound along the tire-circumferential direction D3. The ribbon rubber 10 includes the parallel portion 31, 51 having a first end 31a, 51b which is the end 10a, 10b of the ribbon rubber 10 and placed parallel to the tire-circumferential direction D3 to configure a predetermined row L1 of a tire-width direction D1, and the inclined portion 21, 41 having a first end 21a, 41b connected to a second end 31b, 51a of the parallel portion 31, 51, the inclined portion 21, 41 being placed at a slant with respect to the tire-circumferential direction D3 from the predetermined row L1 of the tire-width direction D1 to the row L2 which is adjacent to the predetermined row L1. The parallel portion 31, 51 includes the standard portion 11 having the same cross-sectional area as a cross-sectional area of the second end 31b, 51a, and the small portion 12 placed close to the first end 31a, 51b and having a cross-sectional area smaller than the cross-sectional area of the standard portion 11. The positions of the first end 31a, 51b and the second end 31b, 51a of the parallel portion 31, 51 are the same in the tire-circumferential direction D3. The portion of the inclined portion 21, 41 is superposed on a portion of the small portion 12. The rubber volume at a location where the inclined portion 21, 41 is located in the predetermined row L1 of the tire-width direction Di is equal to an insufficient rubber volume of the small portion 12 with respect to the standard portion 11 having the same length.

According to this configuration, since the first ends 31a, 51b of the parallel portions 31, 51 are the ends 10a, 10b of the ribbon rubber 10, the first ends 31a, 51b of the parallel portions 31, 51 become the winding-starting end 10a or the winding-finishing end 10b of the ribbon rubber 10. To configure a predetermined row L1 in the tire-width direction D1, the parallel portions 31, 51 are placed parallel to the tire-circumferential direction D3. The parallel portions 31, 51 include the standard portion 11 having the same cross-sectional area as those of the second ends 31b, 51a, and the small portion 12 placed close to the first ends 31a, 51b and having the cross-sectional area smaller than that of the standard portion 11.

The first ends 21a, 41b of the inclined portions 21, 41 are connected to the second ends 31b, 51a of the parallel portion 31, and are placed at a slant with respect to the tire-circumferential direction D3 from the predetermined row L1 in the tire-width direction D1 to the row L2 which is adjacent to the row L1. Positions of the first ends 31a, 51b and the second ends 31b, 51a of the parallel portions 31, 51 in the tire-circumferential direction D3 are the same, and portions of the inclined portions 31, 51 are superposed on a portion of the small portion 12.

A rubber volume at a location where the inclined portions 21, 41 are located in the predetermined row L1 in the tire-width direction D1 is the same as a rubber volume of the small portion 12 which is insufficient with respect to the standard portion 11 having the same length. According to this, in the predetermined row L1 configured by the parallel portions 31, 51, it is possible to restrain a rubber weight from becoming non-uniform in the tire-circumferential direction D3.

In the tire 1 of this embodiment, a cross-sectional shape of the small portion 12 is similar to a cross-sectional shape of the standard portion 11 such that the cross-sectional area of the small portion 12 gradually becomes larger from the first end 31a, 51b of the parallel portion 31, 51 toward the standard portion 11.

According to this configuration, a cross-sectional shape of the small portion 12 is similar to that of the standard portion 11. The cross-sectional area of the small portion 12 gradually becomes larger from the first ends 31a, 51b of the parallel portions 31, 51 toward the standard portion 11. According to this, in the predetermined row L1 configured by the parallel portions 31, 51, it is possible to effectively restrain a rubber weight from becoming non-uniform in the tire-circumferential direction D3.

In the tire 1 of this embodiment, the winding-starting end 31a of the parallel portion 31 is a winding-starting end 10a of the ribbon rubber 10. The parallel portion 31 is placed parallel to the tire-circumferential direction D3 to configure the predetermined row L1 of the tire-width direction D1. The winding-starting end 21a of the inclined portion 21 is connected to the winding-finishing end 31b of the parallel portion 31. The inclined portion 21 is placed at a slant with respect to the tire-circumferential direction D3 from the predetermined row L1 of the tire-width direction D1 toward a row L2 which is adjacent to the predetermined row L1 in the winding direction D31. The portion of the inclined portion 21 is superposed on a portion of the small portion 12 such that the portion of the inclined portion 21 covers the portion of the small portion 12 from outside in a tire-radial direction D2.

In the tire 1 of this embodiment, the inclined portion 41 is placed at a slant with respect to the tire-circumferential direction D3 from the adjacent row L2 of the tire-width direction D1 toward the predetermined row L1 in the winding direction D31. The winding-starting end 51a of the parallel portion 51 is connected to a winding-finishing end 41b of the inclined portion 41. The parallel portion 51 is placed parallel to the tire-circumferential direction D3 to configure the predetermined row L1 of the tire-width direction D1. The winding-finishing end 51b of the parallel portion 51 is the winding-finishing end 10b of the ribbon rubber 10. The portion of the inclined portion 41 is superposed on a portion of the small portion 12 such that the portion of the inclined portion 41 covers the portion of the small portion 12 from outside in a tire-radial direction D2.

The tire is not limited to the configuration and effect of the tire 1 of the second embodiment. For example, the tire 1 of the second embodiment may be changed in the following manners.

In the tire 1 of the second embodiment, the small portions 12 are respectively provided on both the winding-starting end 10a and the winding-finishing end 10b of the ribbon rubber 10. However, the tire is net limited to this configuration. For example, in the tire, the small portion 12 may be provided only on one of the winding-starting end 10a and the winding-finishing end 10b of the ribbon rubber 10.

In the tire 1 of the second embodiment, the ends 10a, 10b of the ribbon rubber 10, i.e., the small portion 12 is placed in the outer first row L1 in the tire-width direction D1. However, the tire is not limited to this configuration. In the tire, for example, the ends 10a, 10b of the ribbon rubber 10, i.e., the small portion 12 may be placed in the outer second row L2 or an outer third row L3 in the tire-width direction D1. In other words, the ends 10a, 10b, i.e., the small portion 12 may be placed on anyone of these rows in the tire-width direction D1.

### Third Embodiment

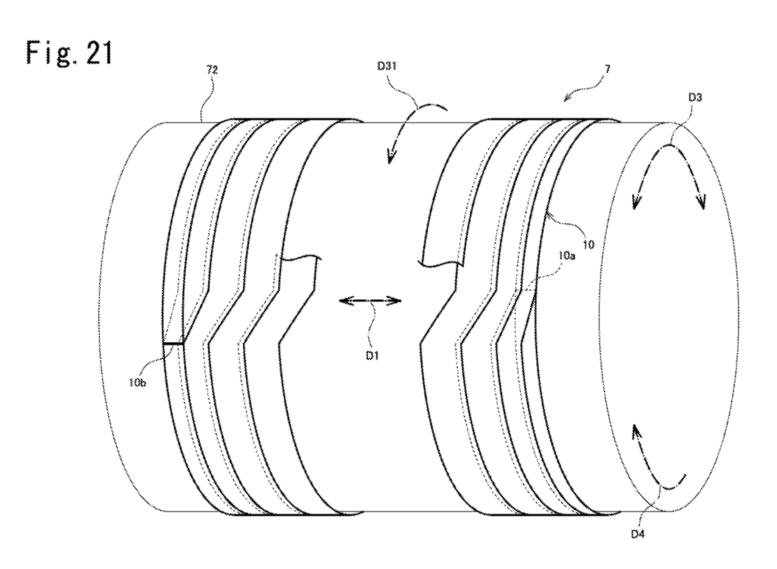

Next, a third embodiment in the tire will be described with reference to FIGS. 21 to 29. In FIGS. 21 to 29, elements to which the same reference signs as those of FIGS. 1 to 12 are denoted have substantially the same configurations or functions (effects) as the first embodiment, and description thereof will not be repeated.

The tire 1 of this embodiment has configurations 2 to 8 as the tire 1 of the first embodiment (see FIGS. 1 to 3), and the tire 1 includes a rubber portion (tread rubber 7 also in this embodiment) formed from ribbon rubber which is spirally wound along the tire-circumferential direction D3 around a rotation axis of the tire. The ribbon rubber 10 and the forming device 70 of this embodiment are substantially the same as those of the first embodiment.

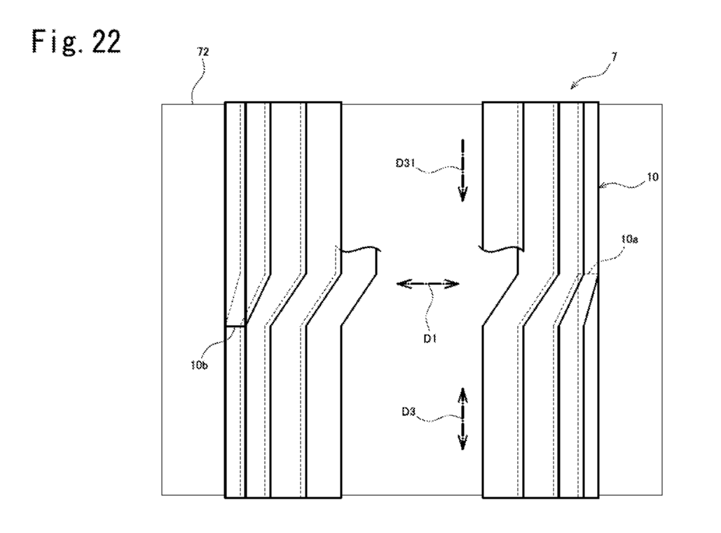

The rubber portion (tread rubber 7) formed by the forming device 70 is shown in FIGS. 21 and 22. A configuration and a method for spirally winding the ribbon rubber 10 along the tire-circumferential direction D3 are substantially the same as those of the first embodiment (see FIGS. 4 and 5).

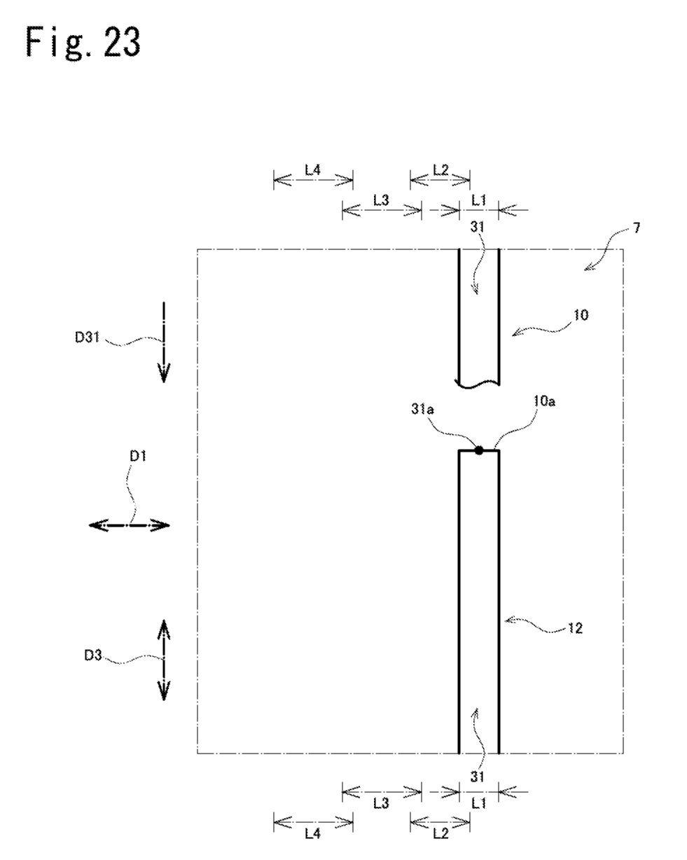

Next, a wound state of the ribbon rubber 10 in the rubber portion (tread rubber 7) will be described with reference to FIGS. 23 to 29 while comparing with a comparative example. Note that a tread rubber 7 of the comparative example is the same as the tread rubber 7 of the comparative example in the first embodiment (see FIGS. 6 and 7). That is, in the comparative example, since a rubber-surplus portion (inclined line region A1 in FIG. 7) is generated in the outer first row L1, a rubber weight of the outer first row L1 becomes non-uniform in the tire-circumferential direction D3.

First, a wound state of a portion of the ribbon rubber 10 of this embodiment close to the winding-starting end 10a will be described with reference to FIGS. 23 to 26.

As shown in FIG. 23, in the tread rubber 7 of this embodiment, the winding-starting end 10a of the ribbon rubber 10 is located in the outer first row L1. The ribbon rubber 10 is wound parallel to the tire-circumferential direction D3 in the outer first row L1. According to this, the first parallel portion 31 is placed parallel to the tire-circumferential direction D3. Therefore, the winding-starting end 10a of the ribbon rubber 10 is the winding-starting end 31a of the first parallel portion 31 which configures the outer first row L1.

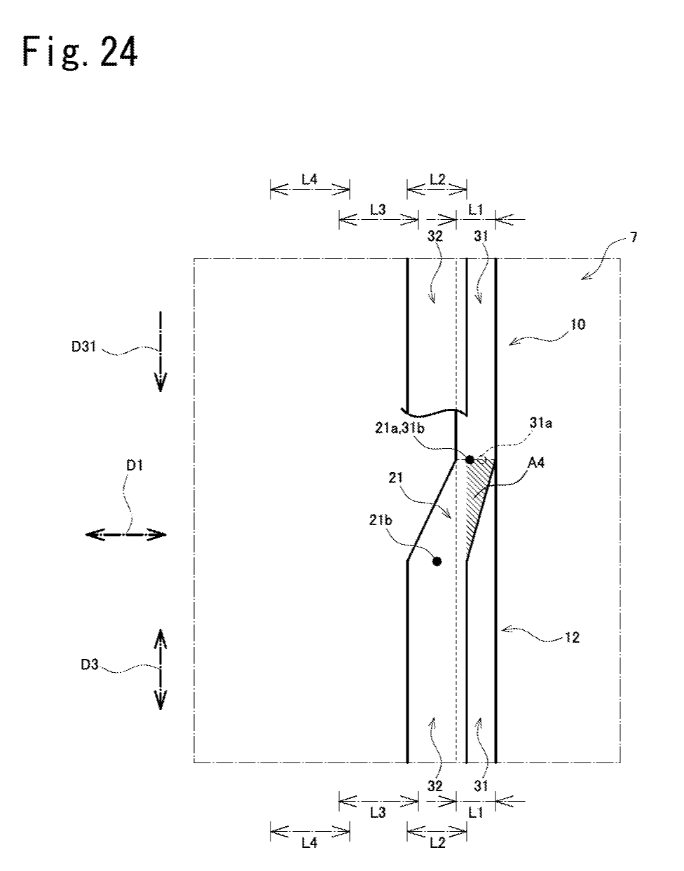

As shown in FIG. 24, the ribbon rubber 10 is wound at a slant with respect to the tire-circumferential direction D3 such that the ribbon rubber 10 moves from the outer first row LI toward the outer second row L2. According to this, the first inclined portion 21 is placed at a slant with respect to the tire-circumferential direction D3 such that the first inclined portion 21 moves from the outer first row L1 toward the outer second row L2 in the winding direction D31.

At this time, the winding-finishing end 31b of the first parallel portion 31 (winding-starting end 21a of the first inclined portion 21) is located at the same position as the winding-starting end 31a of the first parallel portion 31 in the tire-circumferential direction D3. According to this, the outer first row L1 is configured by the first parallel portion 31 and a portion of the first inclined portion 21 close to the winding-starting end 21a. The winding-starting end 31a of the first parallel portion 31 and the winding-starting end 21a of the first inclined portion 21 are superposed on each other in the outer first row L1 and according to this, a rubber-surplus portion (inclined line region in FIG. 24) A4 is generated.

According to the tread rubber 7 of this embodiment, since the first parallel portion 31 and the first inclined portion 21 are configured by the small portion 12, it is possible to suppress a rubber weight of the rubber-surplus portion A4 as compared with the comparative example formed from the ribbon rubber 10 having the uniform cross-sectional area over its entire length. Therefore, in the tread rubber 7 of this embodiment, it is possible to restrain the rubber weight from becoming non-uniform in the tire-circumferential direction D3 in the outer first row L1 as compared with the comparative example.

The cross-sectional area of the first parallel portion 31 is uniform over its entire length. In other words, in the first parallel portion 31, the cross-sectional areas of the winding-starting end 31a and the winding-finishing end 31b are the same (this expression not only includes completely the same but also includes substantially the same). For example, the cross-sectional area of the first parallel portion 31 is 50% of the cross-sectional area of the standard portion 11.

On the other hand, the cross-sectional area of the first inclined portion 21 becomes larger inward in the tire-width direction D1. That is, the cross-sectional area of the first inclined portion 21 becomes larger from the winding-starting end 21a toward the winding-finishing end 21b. For example, a cross-sectional area of the winding-starting end 21a of the first inclined portion 21 is 50% of the cross-sectional area of the standard portion 11, and a cross-sectional area of the winding-finishing end 21b of the first inclined portion 21 is 75% of the cross-sectional area of the standard portion 11.

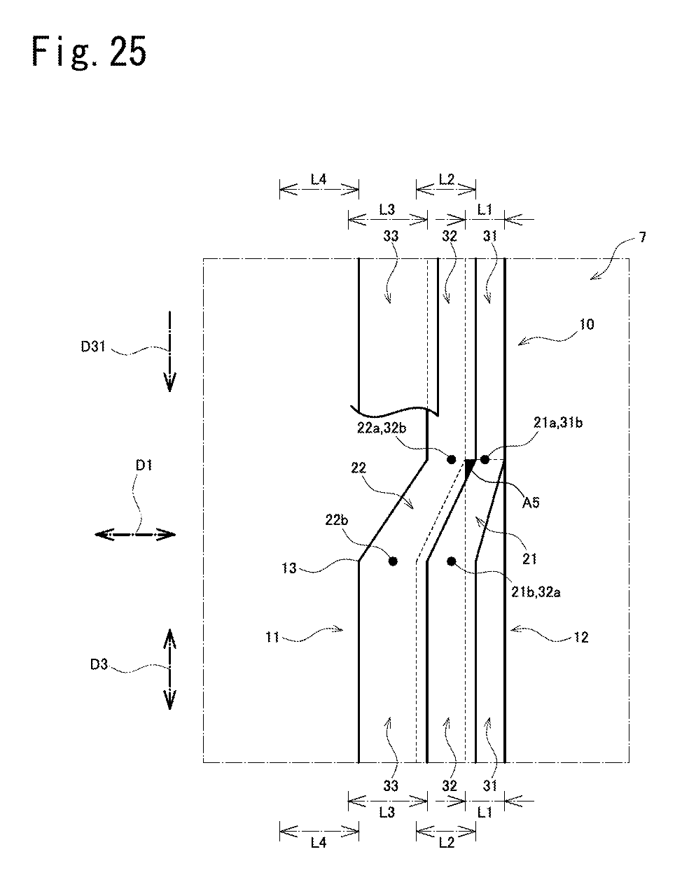

Thereafter, the ribbon rubber 10 is wound parallel to the tire-circumferential direction D3 in the outer second row L2. According to this, the second parallel portion 32 is placed parallel to the tire-circumferential direction D3. As shown in FIG. 25, the ribbon rubber 10 is wound at a slant with respect to the tire-circumferential direction D3 such that the ribbon rubber 10 moves from the outer second row L2 toward the outer third row L3. According to this, a second inclined portion 22 is placed at a slant with respect to the tire-circumferential direction D3 such that the second inclined portion 22 moves from the outer second row L2 toward the cuter third row L3 in the winding direction D31.

At this time, a winding-starting end 22a of the second inclined portion 22 (winding-finishing end 32b of the second parallel portion 32) is located at the same position as the winding-starting end 21a of the first inclined portion 21 (winding-finishing end 31b of first parallel portion 31) in the tire-circumferential direction D3. The winding-finishing end 21b of the first inclined portion 21 (winding-starting end 32a of the second parallel portion 32) is located at the same position as a winding-finishing end 22b of the second inclined portion 22 in the tire-circumferential direction D3.

According to this, a rubber-surplus portion (colored region in FIG. 25) A5 is generated in the outer second row L2 (specifically, region where outer first row L1 and outer second row L2 are superposed on each other). Note that, on the rubber-surplus portion A5, a portion of the first parallel portion 31 close to the winding-starting end 31a, a portion of the first inclined portion 21 close to the winding-starting end 21a and a portion of the second inclined portion 22 close to the winding-starting end 22a are superposed on each other.

According to the tread rubber 7 of this embodiment, since the first parallel portion 31, the first inclined portion 21 and the second inclined portion 22 are configured by the small portion 12, it is possible to suppress a rubber weight of the rubber-surplus portion A5 as compared with the comparative example. Therefore, the tread rubber 7 of this embodiment can restrain a rubber weight from becoming non-uniform in the tire-circumferential direction D3 in the outer second row L2 as compared with the comparative example.

The cross-sectional area of the second parallel portion 32 is uniform over its entire length. That is, in the second parallel portion 32, cross-sectional areas of the winding-starting end 32a and the winding-finishing end 32b are the same (this expression not only includes completely the same but also includes substantially the same). For example, the cross-sectional area of the second parallel portion 32 is 75% of the cross-sectional area of the standard portion 11.

Whereas, the cross-sectional area of the second inclined portion 22 becomes larger inward in the tire-width direction D1. That is, the cross-sectional area of the second inclined portion 22 becomes larger from the winding-starting end 22a toward the winding-finishing end 22b. For example, the cross-sectional area of the winding-starting end 22a of the second inclined portion 22 is 15% of the cross-sectional area of the standard portion 11, and the cross-sectional area of the winding-finishing end 22b of the second inclined portion 22 is 100% of the cross-sectional area of the standard portion 11.

Thereafter, the ribbon rubber 10 is wound parallel to the tire-circumferential direction D3 in the outer third row L3. According to this, a third parallel portion 33 is placed parallel to the tire-circumferential direction D3. The boundary position 13 which is a boundary between the small portion 12 and the standard portion 11 is located between the second inclined portion 22 and the third parallel portion 33.

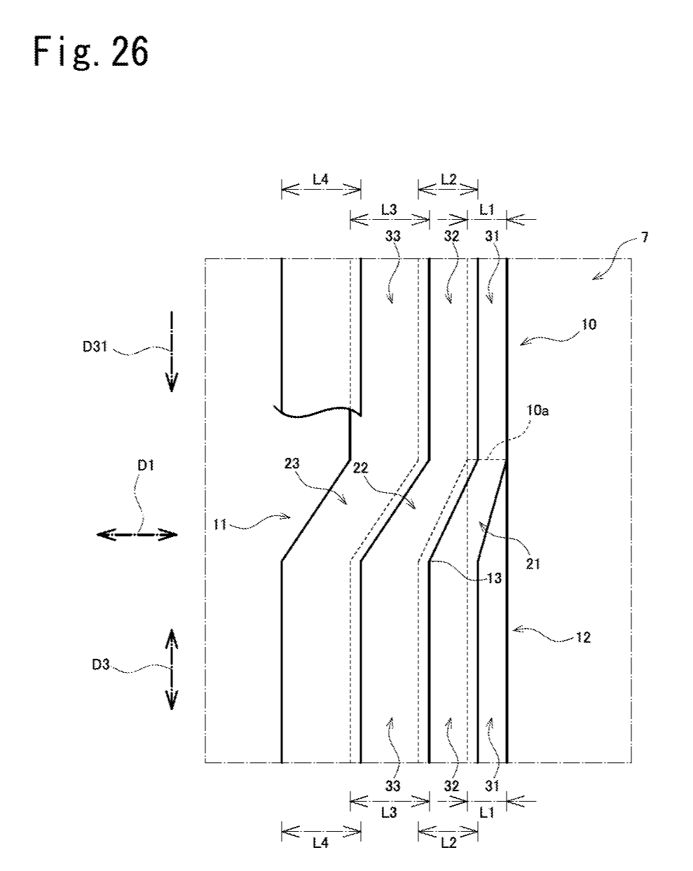

As shown in FIG. 26, the ribbon rubber 10 is wound at a slant with respect to the tire-circumferential direction D3 such that the ribbon rubber 10 moves from the outer third row L3 toward an outer fourth row L4. According to this, a third inclined portion 23 is placed at a slant with respect to the tire-circumferential direction D3 such that the third inclined portion 23 moves from the outer third row L3 toward the outer fourth row L4 in the winding direction D31. Further, the ribbon rubber 10 is switched between a state where it is wound parallel to the tire-circumferential direction D3 and a state where it is wound at a slant with respect to the tire-circumferential direction D3 at the same position in the tire-circumferential direction D3.

In this manner, the tread rubber 7 of this embodiment can suppress the surplus of the rubber amount in the outer first row L1 and the outer second row L2 as compared with the comparative example. Therefore, the tread rubber 7 of this embodiment can restrain a rubber weight of the outer first row L1 and a rubber weight of the outer second row L2 from becoming non-uniform in the tire-circumferential direction D3 as compared with the comparative example.

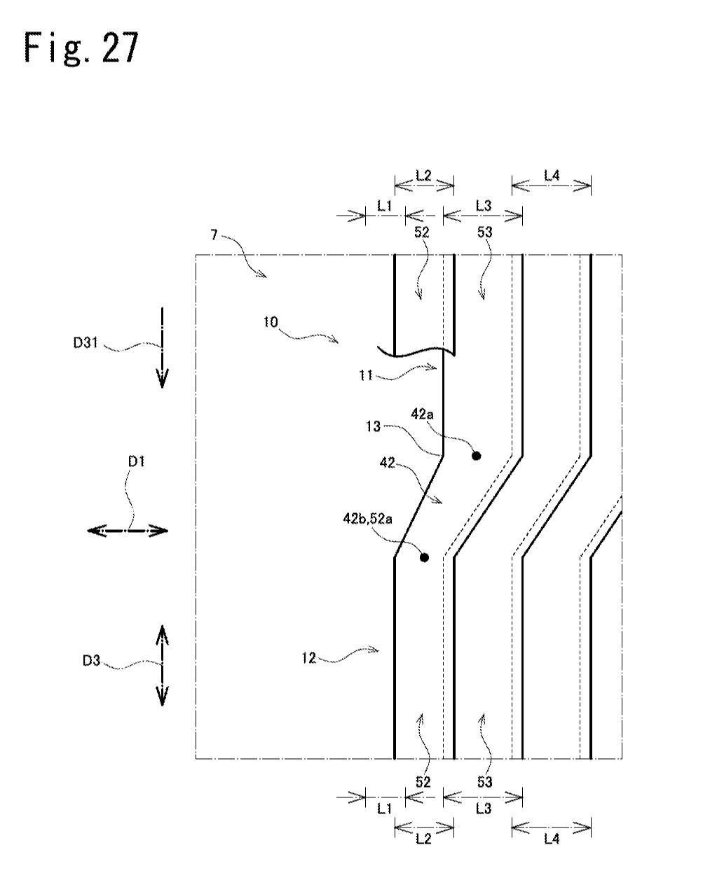

Next, a wound state of a portion of the ribbon rubber 10 of this embodiment close to the winding-finishing end 10b will be described with reference to FIGS. 27 to 29.

As shown in FIG. 27, in the tread rubber 7 of this embodiment, from inside of the tire-width direction D1 to the outer third row L3, the ribbon rubber 10 is switched between a state where it is wound parallel to the tire-circumferential direction D3 and a state where it is wound at a slant with respect to the tire-circumferential direction D3 at the same position in the tire-circumferential direction D3. The ribbon rubber 10 is wound parallel to the tire-circumferential direction D3 in the outer third row L3. According to this, a third parallel portion 53 is placed parallel to the tire-circumferential direction D3.

Thereafter, the ribbon rubber 10 is wound at a slant with respect to the tire-circumferential direction D3 such that the ribbon rubber 10 moves from the outer third row L3 to the outer second row L2. According to this, a second inclined portion 42 is placed at a slant with respect to the tire-circumferential direction D3 such that the second inclined portion 42 moves from the outer third row L3 toward the outer second row L2 in the winding direction D31. The ribbon rubber 10 is wound parallel to the tire-circumferential direction D3 in the outer second row L2. According to this, the second parallel portion 52 is placed parallel to the tire-circumferential direction D3.

Note that, the third parallel portion 53 is configured by the standard portion 11 of the ribbon rubber 10, the second inclined portion 42 and the second parallel portion 52 are configured by the small portion 12 of the ribbon rubber 10. That is, the boundary position 13 which is the boundary between the small portion 12 and the standard portion 11 is a position between the third parallel portion 53 and the second inclined portion 42.

The cross-sectional area of the second inclined portion 42 becomes larger inward of the tire-width direction Di. That is, the cross-sectional area of the second inclined portion 42 becomes smaller from a winding-starting end 42a toward a winding-finishing end 42b. For example, a cross-sectional area of the winding-starting end 42a of the second inclined portion 42 is 100% of the cross-sectional area of the standard portion 11, and a cross-sectional area of the winding-finishing end 42b of the second inclined portion 42 is 75% of the cross-sectional area of the standard portion 11.

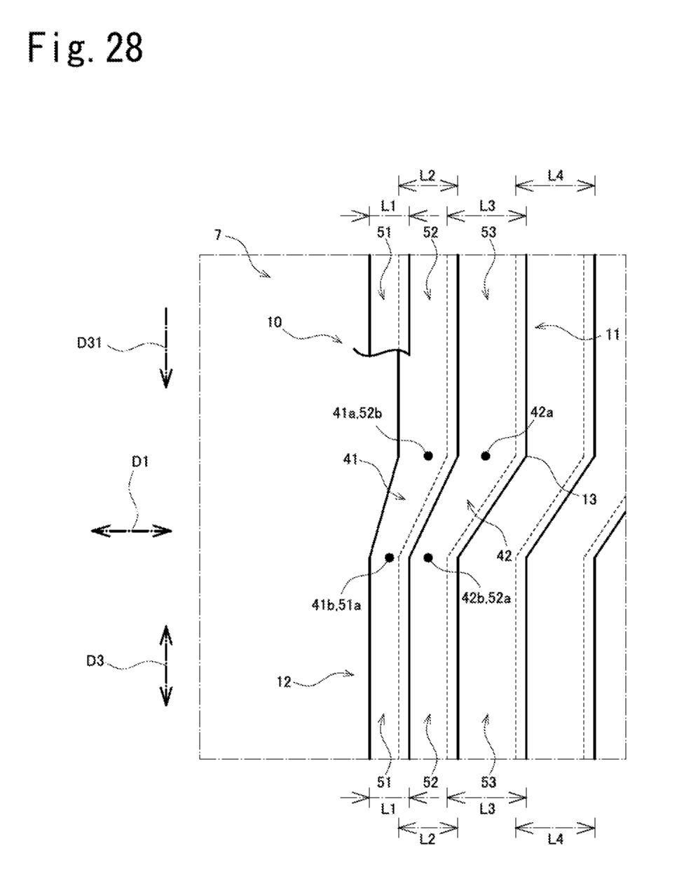

Thereafter, as shown in FIG. 28, the ribbon rubber 10 is wound at a slant with respect to the tire-circumferential direction D3 such that the ribbon rubber 10 moves from the outer second row L2 toward the outer first row L1. According to this, the first inclined portion 41 is placed at a slant with respect to the tire-circumferential direction D3 such that the first inclined portion 41 moves from the outer second row L2 toward the outer first row L1. The ribbon rubber 10 is wound parallel to the tire-circumferential direction D3 in the outer first row L1. According to this, the first parallel portion 51 is placed parallel to the tire-circumferential direction D3.

At this time, the winding-starting end 41a of the first inclined portion 41 (winding-finishing end 52b of second parallel portion 52) is located at the same position as the winding-starting end 42a of the second inclined portion 42 in the tire-circumferential direction D3. The winding-finishing end 41b of the first inclined portion 41 (winding-starting end 51a of first parallel portion 51) is located at the same position as the winding-finishing end 42b of the second inclined portion 42 (winding-starting end 52a of the second parallel portion 52) in the tire-circumferential direction D3.

Note that, a cross-sectional area of the second parallel portion 52 is uniform over its entire length. That is, an the second parallel portion 52, cross-sectional areas of the winding-starting end 52a and the winding-finishing end 52b are the same (this expression not only includes completely the same but also includes substantially the same). For example, the cross-sectional area of the second parallel portion 52 is 15% of the cross-sectional area of the standard portion 11.

On the other hand, the cross-sectional area of the first inclined portion 41 becomes larger inward of the tire-width direction D1. That is, the cross-sectional area of the first inclined portion 41 becomes smaller from the winding-starting end 41a toward the winding-finishing end 41b. For example, the cross-sectional area of the winding-starting end 41a of the first inclined portion 41 is 75% of the cross-sectional area of the standard portion 11, and the cross-sectional area of the winding-finishing end 41b of the first inclined portion 41 is 50% of the cross-sectional area of the standard portion 11.

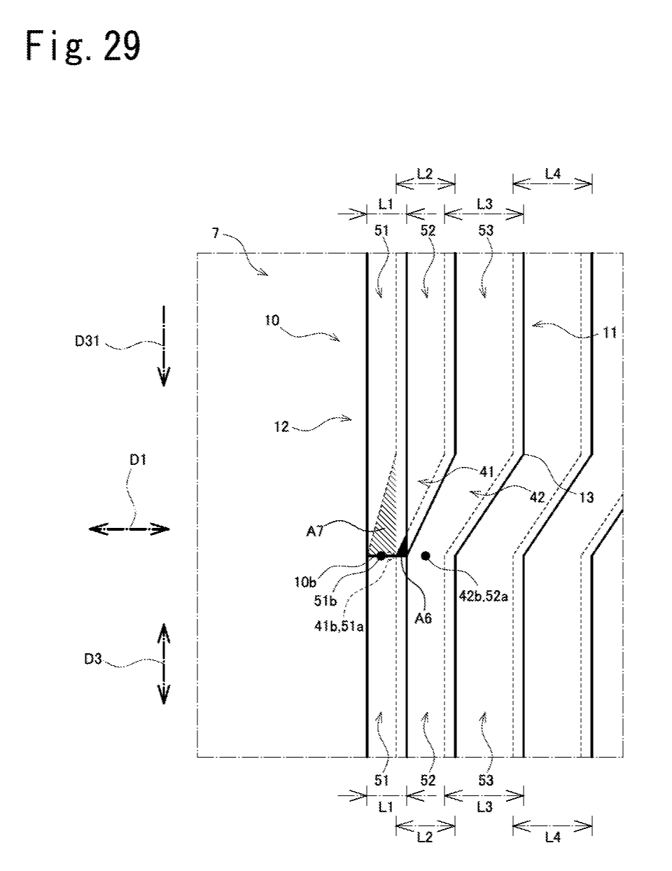

Thereafter, as shown in FIG. 29, the winding-finishing end 10b of the ribbon rubber 10 is located in the outer first row L1 in the tread rubber 7 of this embodiment. That is, the winding-finishing end 10b of the ribbon rubber 10 is the winding-finishing end 51b of the first parallel portion 51 which configures the outer first row L1. At this time, the winding-finishing end 51b of the first parallel portion 51 is located at the same position as the winding-starting end 51a of the first parallel portion 51 (winding-finishing end 41b of first inclined portion 41).

The cross-sectional area of the first parallel portion 51 is uniform over its entire length. That is, in the first parallel portion 51, the cross-sectional areas of the winding-starting end 51a and the winding-finishing end 51b are the same (this expression not only includes completely the same but also includes substantially the same). For example, the cross-sectional area of the first parallel portion 51 is 50% of the cross-sectional area of the standard portion 11.

Meanwhile, a rubber-surplus portion (colored region in FIG. 29) A6 is generated in the cuter second row L2 (specifically, region where outer first row L1 and outer second row L2 are superposed on each other). Note that, on the rubber-surplus portion A6, a portion of the second inclined portion 42 close to the winding-finishing end 42b, a portion of the first inclined portion 41 close to the winding-finishing end 41b, and a portion of the first parallel portion 51 close to the winding-finishing end 51b are superposed on each other.

In the tread rubber 7 of this embodiment, since the second inclined portion 42, the first inclined portion 41 and the first parallel portion 51 are configured by the small portion 12, it is possible to suppress a rubber weight at the rubber-surplus portion A6 as compared with the comparative example. Therefore, the tread rubber 7 of this embodiment can restrain the rubber weight from becoming non-uniform in the tire-circumferential direction D3 in the outer second row L2 as compared with the comparative example.

Further, a rubber-surplus portion (inclined line region in FIG. 29) A7 is generated in the outer first row L1. On the rubber-surplus portion A7, a portion of the first inclined portion 41 close to the winding-finishing end 41b and a portion of the first parallel portion 51 close to the winding-finishing end 51b are superposed on each other.

Hence, in the tread rubber 7 of this embodiment, since the first inclined portion 41 and the first parallel portion 51 are configured by the small portion 12, it is possible to suppress a rubber weight of the rubber-surplus portion A7 as compared with the comparative example. Therefore, the tread rubber 7 of this embodiment can restrain the rubber weight from becoming non-uniform in the tire-circumferential direction D3 in the outer first row L1 as compared with the comparative example.

As described above, the tread rubber 7 of this embodiment can suppress surplus of the rubber amount in the outer first row L1 and the outer second row L2 as compared with the comparative example. Therefore, the tread rubber 7 of this embodiment can restrain the rubber weight from becoming non-uniform in the tire-circumferential direction D3 in the outer first row L1 and the outer second row L2 as compared with the comparative example.

The tire 1 of this embodiment includes the rubber portion (tread rubber 7 in this embodiment) formed from ribbon rubber 10 which is spirally wound along the tire-circumferential direction D3. The ribbon rubber 10 is alternately provided with parallel portions 31 to 33 and 51 to 53 placed parallel to the tire-circumferential direction D3, and inclined portions 21 to 23 and 41 to 42 which are inclined with respect to the tire-circumferential direction D3 and placed between adjacent two rows L1 to LA of the tire-width direction D1, such that the ribbon rubber 10 is spirally wound along the tire-circumferential direction D3. The end 10a, 10b of the ribbon rubber 10 in the length direction is the end 31a, 51b of the parallel portion 31, 51 which configures the predetermined row L1 of the tire-width direction D1. The ribbon rubber 10 includes a standard portion 11 placed at the intermediate portion in the length direction and having a uniform cross-sectional area, and the small portion 12 placed on the end 10a, 10b in the length direction and having a cross-sectional area smaller than a cross-sectional area of the standard portion 11. At least the predetermined row L1 of the tire-width direction D1 and the row L2 which is adjacent to the predetermined row L1 are configured by the small portion 12.

According to this configuration, to configure the predetermined rows L1 to L3 in the tire-width direction D1, the parallel portions 31 to 33 and 51 to 53 are placed parallel to the tire-circumferential direction D3, the inclined portions 21 to 23 and 41 to 42 are inclined with respect to the tire-circumferential direction D3 and placed between the rows L1 to L4 which are adjacent to each other in the tire-width direction D1. The parallel portions 31 to 33 and 51 to 53 and the inclined portions 21 to 23 and 41 to 42 are alternately provided. According to this, the ribbon rubber 10 is spirally wound along the tire-circumferential direction D3.

Since the ends 10a, 10b in the length direction of the ribbon rubber 10 are ends 31a, 51b of the parallel portions 31, 51 which configure the predetermined row L1 in the tire-width direction D1, the ends 31a, 51b of the parallel portions 31, 51 become the winding-starting end 10a (or winding-finishing end 10b) of the ribbon rubber 10. According to this, the ribbon rubber sets 10 are superposed on each other in the predetermined row L1 in the tire-width direction D1 and the row L2 which is adjacent to the row L1, the rubber-surplus portions A4 to A7 are generated.

The ribbon rubber 10 includes the standard portion 11 which is placed at an intermediate portion in the length direction and which has the uniform cross-sectional area, and the small portion 12 which is placed on the side of the ends 10a, 10b in the length direction and which has the cross-sectional area smaller than that of the standard portion 11. At least the predetermined row L1 in the tire-width direction D1 and the row L2 which is adjacent to the row L1 are configured by the small portion 12.

According to this, it is possible to suppress the surplus of a rubber amount in the predetermined row L1 in the tire-width direction D1 and the row L2 which is adjacent to the row L1. Therefore, a rubber weight of the predetermined row L1 in the tire-width direction D1 and the row L2 which is adjacent to the row L1 is restrained from becoming non-uniform.

In the tire 1 of this embodiment, a cross-sectional area of the parallel portion 31, 32, 51, 52 configured by the small portion 12 is uniform. A cross-sectional area of the inclined portion 21, 22, 41, 42 configured by the small portion 12 becomes larger from the end 10a, 10b of tie ribbon rubber 10 in the length direction toward the standard portion 11.

According to this configuration, the cross-sectional areas of the parallel portions 31, 32, 51 and 52 configured by the small portion 12 are uniform, and the cross-sectional areas of the inclined portions 21, 22, 41 and 42 configured by the small portion 12 become larger from the ends 10a, 10b in the length direction of the ribbon rubber 10 toward the standard portion 11. According to this, in the parallel portions 31, 32, 51 and 52, since the rubber weight is uniform in the tire-circumferential direction D3, it is possible to effectively restrain the rubber weight from becoming non-uniform in the tire-circumferential direction D3.

The tire is not limited to the configuration and effect of the tire 1 of the third embodiment. For example, the tire 1 of the third embodiment may be changed in the following manners.

In the tire 1 of the third embodiment, the cross-sectional areas of the parallel portions 31, 32, 51 and 52 configured by the small portion 12 are uniform, and the cross-sectional areas of the inclined portions 21, 22, 41 and 42 configured by the small portion 12 become larger from the ends 10a, 10b in the length direction of the ribbon rubber 10 toward the standard portion 11. However, the tire is not limited to this configuration. In the tire, for example, the cross-sectional area of the small portion 12 may gradually become larger from the ends 10a, 10b in the length direction of the ribbon rubber 10 toward the standard portion 11.

According to this configuration, since the cross-sectional area of the small portion 12 gradually becomes larger from the ends 10a, 10b in the length direction of the ribbon rubber 10 toward the standard portion 11, the rubber weight is gradually varied in the tire-circumferential direction D3. According to this, it is possible to effectively restrain the rubber weight from becoming non-uniform in the tire-circumferential direction D3.

In the tire 1 of the third embodiment, the outer first row L1 and the outer second row L2 in the tire-width direction D1 are configured by the small portion 12. However, the tire is not limited to this configuration. More specifically, in the tire, it is only necessary that the predetermined row in the tire-width direction D1 where the ends 10a, 10b in the length direction of the ribbon rubber 10, as well as a row which is adjacent to the predetermined row are configured by the small portion 12.

In the tire, for example, it is possible to employ the following configuration that the rubber portion is the tread rubber 7, the tread rubber 7 includes a plurality of peripheral grooves 7c, 7s extending along the tire-circumferential direction D3, the shoulder region 4s located outside of the peripheral groove 7c placed on the outermost side of the tire-width direction D1 of the tread rubber 7 has a size in the tire-radial direction D2 smaller than that of the inner center region 4c, and the ends 10a, 10b in the length direction of the ribbon rubber 10 are placed in the shoulder region 4s, and the shoulder region 4s is configured by the small portion 12.

According to this configuration, the rubber portion formed from the ribbon rubber 10 is the tread rubber 7, and the tread rubber 7 includes the plurality of peripheral grooves 7c, 7s extending along the tire-circumferential direction D3. The peripheral grooves 7s are placed on the outermost side in the tire-width direction D1. Of the tread rubber 7, the shoulder region 4s outside of the peripheral grooves 7s in the tire-width direction D1 has a size in the tire-radial direction D2 smaller than that of the inner center region 4c.

Hence, the ends 10a, 10b in the length direction of the ribbon rubber 10 are placed in the shoulder region 4s, and the shoulder region 4s is configured by the small portion 12. According to this, the size of the shoulder region 4s can easily be set to the tire-radial direction D2 which is smaller than the center region 4c. In FIG. 1, the ends 10a, 10b in the length direction of the ribbon rubber 10 are placed in the outer first row L1, and a size of the shoulder region 4s of the tread rubber 7 in the tire-radial direction D2 gradually becomes larger inward of the tire-width direction D1.

In the tire 1 of the third embodiment, the small portions 12 are placed both on the side of the winding-starting end 10a and on the side of the winding-finishing end 10b of the ribbon rubber 10. However, the tire is not limited to this configuration. For example, in the tire, the small portion 12 may be provided only on the side of one of the winding-starting end 10a and the winding-finishing end 10b of the ribbon rubber 10.

In the tire 1 of the third embodiment, the ends 10a, 10b of the ribbon rubber 10 are placed in the outer first row L1 in the tire-width direction D1. However, the tire is not limited to this configuration. For example, in the tire, the ends 10a, 10b of the ribbon rubber 10 may be placed in the outer second row L2 or the outer third row L3 in the tire-width direction D1, i.e., the ends 10a, 10b may be placed any of rows in the tire-width direction D1.

Note that, the tire and the manufacturing method of the tire are not limited to the configurations of the above-described embodiment, and are not limited to the above-described working effects. The tire and the manufacturing method of the tire can of course be variously modified within a scope not departing from the subject matters of the present invention. For example, the configurations and methods of the above-described plurality of embodiments may arbitrarily be employed and combined (configuration or method of one of embodiments may be applied to configuration or method of other embodiment), and it is possible to arbitrarily select one or more of configurations and methods of the later-described various modifications, and such configurations and methods may be employed for the configurations or the methods of the above-described embodiments.

In the tires 1 of the first to third embodiments, the cross-sectional area of the ribbon rubber 10 is changed (i.e., small portion 12 is formed) by expanding the ribbon rubber 10. However, the tire is not limited to this configuration. In the tire, for example, the cross-sectional area of the ribbon rubber 10 may be changed by changing a cross-sectional shape of rubber which is pushed out from the push-out portion 71, or by changing a push-out amount of rubber per unit time from the push-out portion 71.

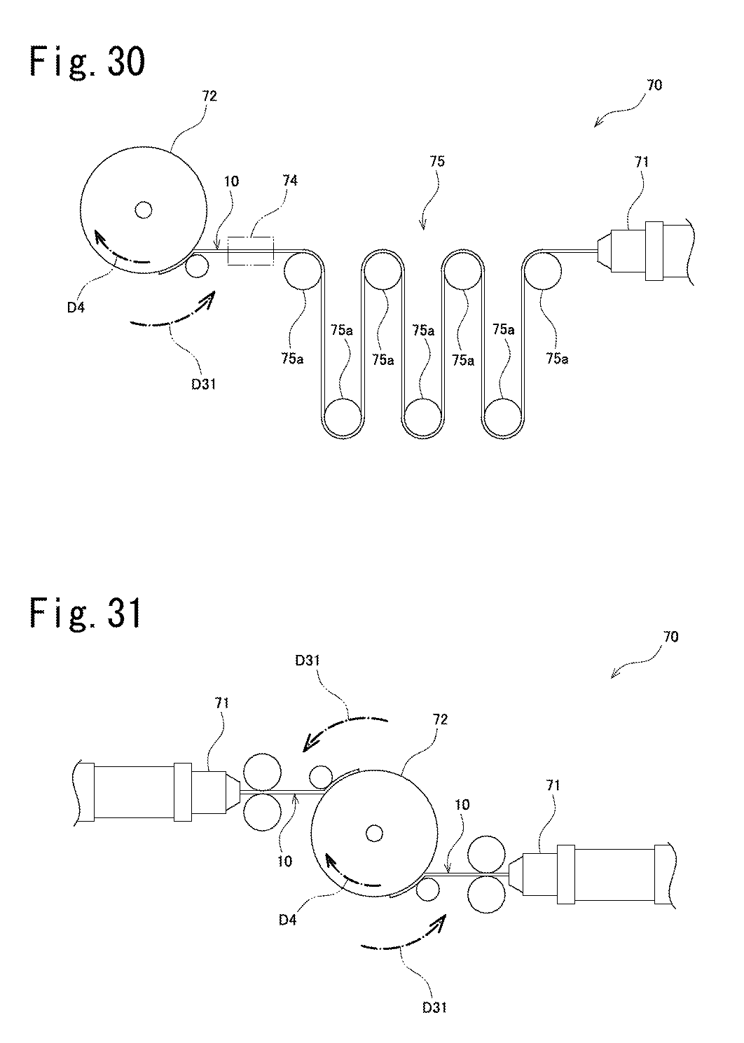

Further, in the tires 1 of the first to third embodiments, the tensile force to be applied to the ribbon rubber 10 is changed, by changing the rotation speed of the winding portion 72, and the cross-sectional area of the ribbon rubber 10 is changed (i.e., small portion 12 is formed). However, the tire is not limited to this configuration. In the tire, for example, the cross-sectional area of the ribbon rubber 10 may be changed by making a tensile mechanism 74 pull the ribbon rubber 10 as shown in FIG. 30.

A forming device 70 shown in FIG. 30 includes a transfer mechanism 75 for transferring a ribbon rubber 10 pushed out from the push-out portion 71 toward the winding portion 72, and a tensile mechanism 74 for grasping and pulling the ribbon rubber 10. Note that, the transfer mechanism 75 may have a configuration that it includes a plurality of transfer rollers 75a, the transfer mechanism 75 pulls the ribbon rubber 10 by changing a distance between the transfer rollers 75a, 75a, thereby changing the cross-sectional area. That is, the transfer mechanism 75 may also serve as the tensile mechanism 74.

Further, in the tires 1 of the first to third embodiments. the forming device 70 which forms the rubber portion (tread rubber 7) includes one push-out portion 71 with respect to one winding portion 72. However, the tire is not limited to this configuration.

In the tire, for example, as shown in FIG. 31, the forming device 70 may include a plurality of (two in FIG. 31) push-out portions 71 with respect to one winding portion 72. Note that, in the rubber portion (tread rubber 7) of the first embodiment formed in the forming device 70 of FIG. 31, there are provided two outermost inclined portions 20, 40, two first parallel portions 31, 51, and two first inclined portions 21, 41 at the ends of the tire-width direction D1.

In the rubber portion (tread rubber 7) of this embodiment formed in the forming device 70 of FIG. 31, two small portions 12 are provided in the predetermined row L1 in the tire-width direction D1. In the rubber portion (tread rubber 7) of this embodiment formed in the forming device 70 of FIG. 31, for example, two ends 10a, 10b in the length direction of the ribbon rubber 10 are provided in the predetermined row in the tire-width direction D1.

In the tires 1 of the first to third embodiments, the cross-sectional shape of the small portion 12 is similar to the cross-sectional shape of the standard portion 11. However, the tire is not limited to this configuration. In the tire, for example, the cross-sectional shape of the small portion 12 may not be similar to the cross-sectional shape of the standard portion 11.

In the tire 1 of the first to third embodiments, the cross-sectional area of the snail portion 12 becomes continuously larger from the first ends 31a, 51b of the parallel portions 31, 51 toward the standard portion 11. However, the tire is not limited to this configuration. In the tire, for example, the cross-sectional area of the small portion 12 may become larger from the first ends 31a, 51b of the parallel portions 31, 51 toward the standard portion 11 in a stepwise manner.

In the tire 1 of the first to third embodiments, the rubber portion formed from the ribbon rubber 10 which is spirally wound along the tire-circumferential direction D3 is the tread rubber 7. However, the tire is not limited to this configuration. In the tire, for example, the rubber portion formed from the ribbon rubber 10 may be a portion of the tread rubber 7, or may be other rubber 2b, 3a, 6. In short, the rubber portion formed from the ribbon rubber 10 is not limited.

According to the manufacturing method of the tire 1 of the first to third embodiments, the small portions 12 are formed on the side of the ends 10a, 10b of the ribbon rubber 10. However, the tire manufacturing method is not limited to this method. For example, in the tire manufacturing method, the small portions 12 may be formed at an intermediate portion of the ribbon rubber 10, or a plurality of small portions 12 may intermittently be formed on one ribbon rubber 10.

Further, a tire before vulcanization (unvulcanized tire) and a tire after vulcanization (vulcanized tire) are also included as the tire 1. In the tire after vulcanization, if the tire 1 is cut with a sharp cutting knife, it is possible to observe a boundary surface of the ribbon rubber 10 from its cross section. According to this, it is possible to specify a wound state of the ribbon rubber 10.

What is claimed is:

1. A tire comprising:
a rubber portion formed from ribbon rubber which is spirally wound along a tire-circumferential direction, wherein
the ribbon rubber includes:
a first inclined portion which is placed at a slant with respect to the tire-circumferential direction from an outer second row of a tire-width direction to an outer first row;
a first parallel portion having an end connected to an end of the first inclined portion, the first parallel portion being placed parallel to the tire-circumferential direction to configure the outer first row of the tire-width direction; and
an outermost inclined portion having an end connected to an end of the first parallel portion, the outermost inclined portion being placed at a slant with respect to the tire-circumferential direction, and
wherein the outermost inclined portion is placed along the first inclined portion, and is placed outside of the outer first row from the outer first row of the tire-width direction.

2. The tire according to claim 1, wherein
a cross-sectional area of the outermost inclined portion is smaller than a cross-sectional area of the first parallel portion.

3. The tire according to claim 1, wherein
the outermost inclined portion is placed at a slant with respect to the tire-circumferential direction from outside of the outer first row of the tire-width direction toward the outer first row in a winding direction,
a winding-starting end of the first parallel portion is connected to a winding-finishing end of the outermost inclined portion, the first parallel portion is placed parallel to the tire-circumferential direction to configure the outer first row of the tire-width direction, and
a winding-starting end of the first inclined portion is connected to a winding-finishing end of the first parallel portion, and the first inclined portion is placed at a slant with respect to the tire-circumferential direction from the outer first row of the tire-width direction toward an outer second row in the winding direction.

4. The tire according to claim 1, wherein
the first inclined portion is placed at a slant with respect to the tire-circumferential direction from the outer second row of the tire-width direction toward the outer first row in the winding direction,
a winding-starting end of the first parallel portion is connected to a winding-finishing end of the first inclined portion, the first parallel portion is placed parallel to the tire-circumferential direction to configure the outer first row of the tire-width direction, and
a winding-starting end of the outermost inclined portion is connected to a winding-finishing end of the first parallel portion, and the outermost inclined portion is placed at a slant with respect to the tire-circumferential direction from the outer first row of the tire-width direction toward outside of the outer first row in the winding direction.

5. A tire comprising;
a rubber portion formed from ribbon rubber which is spirally wound along a tire-circumferential direction, wherein
the ribbon rubber includes:
a parallel portion having a first end which is an end of the ribbon rubber and placed parallel to the tire-circumferential direction to configure a predetermined row of a tire-width direction, and
an inclined portion having a first end connected to a second end of the parallel portion, the inclined portion being placed at a slant with respect to the tire-circumferential direction from the predetermined row of the tire-width direction to a row which is adjacent to the predetermined row, and
the parallel portion includes a standard portion having the same cross-sectional area as a cross-sectional area of the second end, and a small portion placed close to the first end and having a cross-sectional area smaller than the cross-sectional area of the standard portion,
wherein positions of the first end and the second end of the parallel portion are the same in the tire-circumferential direction, and
a portion of the inclined portion is superposed on a portion of the small portion, and
a rubber volume at a location where the inclined portion is located in the predetermined row of the tire-width direction is equal to an insufficient rubber volume of the small portion with respect to the standard portion having the same length.

6. The tire according to claim 5, wherein
a cross-sectional shape of the small portion is similar to a cross-sectional shape of the standard portion such that the cross-sectional area of the small portion gradually becomes larger from the first end of the parallel portion toward the standard portion.

7. The tire according to claim 5, wherein
a winding-starting end of the parallel portion is a winding-starting end of the ribbon rubber, the parallel portion is placed parallel to the tire-circumferential direction to configure the predetermined row of the tire-width direction,
a winding-starting end of the inclined portion is connected to a winding-finishing end of the parallel portion, the inclined portion is placed at a slant with respect to the tire-circumferential direction from the predetermined row of the tire-width direction toward a row which is adjacent to the predetermined row in the winding direction, and
a portion of the inclined portion is superposed on a portion of the small portion such that the portion of the inclined portion covers the portion of the small portion from outside in a tire-radial direction.

8. The tire according to claim 5, wherein
the inclined portion is placed at a slant with respect to the tire-circumferential direction from the adjacent row of the tire-width direction toward the predetermined row in the winding direction,
the winding-starting end of the parallel portion is connected to a winding-finishing end of the inclined portion, the parallel portion is placed parallel to the tire-circumferential direction to configure the predetermined row of the tire-width direction, the winding-finishing end of the parallel portion is a winding-finishing end of the ribbon rubber, and
a portion of the inclined portion is superposed on a portion of the small portion such that the portion of the inclined portion covers the portion of the small portion from outside in a tire-radial direction.

9. A tire comprising;
a rubber portion formed from ribbon rubber which is spirally wound along a tire-circumferential direction, wherein
the ribbon rubber is alternately provided with parallel portions placed parallel to the tire-circumferential direction, and inclined portions which are inclined with respect to the tire-circumferential direction and placed between adjacent two rows of a tire-width direction, such that the ribbon rubber is spirally wound along the tire-circumferential direction,
an end of the ribbon rubber in a length direction is an end of the parallel portion which configures a predetermined row of the tire-width direction,
the ribbon rubber includes a standard portion placed at an intermediate portion in the length direction and having a uniform cross-sectional area, and a small portion placed on an end in the length direction and having a cross-sectional area smaller than a cross-sectional area of the standard portion, and
at least the predetermined row of the tire-width direction and the row which is adjacent to the predetermined row are configured by the small portion.

10. The tire according to claim 9, wherein
a cross-sectional area of the parallel portion configured by the small portion is uniform, and
a cross-sectional area of the inclined portion configured by the small portion becomes larger from an end of the ribbon rubber in the length direction toward the standard portion.

11. The tire according to claim 9, wherein
a cross-sectional area of the small portion gradually becomes larger from the end of the ribbon rubber in the length direction toward the standard portion.

12. The tire according to claim 9, wherein
the rubber portion is a tread rubber,
the tread rubber includes a plurality of peripheral grooves extending along the tire-circumferential direction,
a shoulder region in the tire-width direction of the tread rubber located outside of the peripheral grooves which is placed on outermost side in the tire-width direction has a thickness in a tire-radial direction which is smaller than an inner center region,
an end of the ribbon rubber in the length direction is placed in the shoulder region, and
the shoulder region is configured by the small portion.

13. A manufacturing method of a tire including a rubber portion formed from ribbon rubber which is spirally wound along a tire-circumferential direction, the method comprising:
pushing out rubber to form the ribbon rubber having a uniform cross-sectional shape,
winding the ribbon rubber around a rotating winding portion, and
changing a cross-sectional area of the wound ribbon rubber by changing a tensile force to be applied to the ribbon rubber for expanding the ribbon rubber.

14. The manufacturing method of a tire according to claim 13, wherein
rotation speed of the winding portion is changed in order to change the tensile force to be applied to the ribbon rubber.
